(19) United States
(12) Patent Application Publication
(10) Pub. No.: US 2019/0264773 A1
(43) Pub. Date: Aug. 29, 2019

(54) DAMPER DEVICE

(71) Applicants: AISIN AW INDUSTRIES CO., LTD, Echizen-shi, Fukui (JP); AISIN AW CO., LTD., Anjo-shi, Aichi (JP)

(72) Inventors: Takuya YOSHIKAWA, Echizen-shi (JP); Aki OGAWA, Echizen-shi (JP); Ryosuke OTSUKA, Echizen-shi (JP); Akiyoshi KATO, Echizen-shi (JP); Yoichi OI, Anjo-shi (JP); Masaki WAJIMA, Anjo-shi (JP)

(73) Assignees: AISIN AW INDUSTRIES CO., LTD, Echizen-shi, Fukui (JP); AISIN AW CO., LTD., Anjo-shi, Aichi (JP)

(21) Appl. No.: 16/331,019

(22) PCT Filed: Aug. 24, 2017
(86) PCT No.: PCT/JP2017/030384

§ 371 Date: Mar. 6, 2019

(30) Foreign Application Priority Data
Oct. 27, 2016 (JP) 2016-210787

(51) Int. Cl. F16F 15/123; F16F 15/12; F16F 15/129; F16D 7/02; F16F 15/14; F16D 3/12

(52) U.S. Cl. CPC F16F 15/12353; F16F 15/1202; F16F 15/129; F16F 15/1207; F16D 7/025; F16H 45/02; F16F 15/1478; F16D 3/12; F16F 2222/04; F16F 2222/08; F16F 2232/02; F16F 15/123

(57) ABSTRACT

A damper device includes an input element to which a torque from an engine is transmitted; an intermediate element; an output element; a first elastic body arranged to transmit a torque between the input element and the intermediate element; a second elastic body arranged to transmit a torque between the intermediate element and the output element; a rotary inertia mass damper that includes a mass body rotating in accordance with relative rotation between the input element and the output element and that is arranged between the input element and the output element to be parallel to a torque transmission path including the first elastic body, the intermediate element and the second elastic body; and an attenuation mechanism configured to attenuate resonance of the intermediate element.

### TECHNICAL FIELD

The present disclosure relates to a damper device including an elastic body arranged to transmit a torque between an input element and an output element and a rotary inertia mass damper.

### BACKGROUND

A conventionally known configuration of this damper device includes a first spring arranged to transmit a torque between a drive member (input element) and an intermediate member (intermediate element) ; a second spring arranged to transmit a torque between the intermediate member and a driven member (output element) ; and a rotary inertia mass damper provided parallel to a torque transmission path including the intermediate member, the first spring and the second spring and configured to include a sun gear as a mass body rotating with relative rotation between the drive member and the driven member (as described in, for example, Patent Literature 1). In this damper device, on the assumption that an input torque transmitted from an engine to the drive member periodically vibrates, the phase of the vibration transmitted from the drive member to the driven member via the torque transmission path shifts by 180 degrees from the phase of the vibration transmitted from the drive member to the driven member via the rotary inertia mass damper. In this damper device, a damping ratio ζ of the intermediate member that is determined based on moment of inertia of the intermediate member and stiffnesses of the first and the second springs is less than a value 1. In the torque transmission path including the intermediate element, in the state that deflections of the first and second elastic bodies are allowed, a plurality of natural frequencies (resonance frequencies) are set, and resonance of the intermediate element is made to occur when the rotation speed of the input element reaches a rotation speed corresponding to one of the plurality of natural frequencies. As a result, this damper device is capable of setting two antiresonance points where the vibration transmitted from the input element to the output element via the torque transmission path and the vibration transmitted from the input element to the output element via the rotary inertia mass damper are theoretically cancelled out each other. The vibration damping performance of the damper device is improved by making the frequencies of the two antiresonance points equal to (or closer to) the frequency of a vibration (resonance) that is to be attenuated by the damper device.

### CITATION LIST

### Patent Literature

Patent Literature 1: WO 2016/104783A

### SUMMARY

In the damper device described above, however, when the damping ratio ζ of the intermediate member decreases according to the magnitude of moment of inertia of the intermediate member or the like, this makes it difficult to converge the vibration of the intermediate member and increases the amplitude of the resonance of the intermediate member. The increase in the amplitude of the resonance of the intermediate member causes an insufficiency of an inertia torque transmitted from the rotary inertia mass damper to the output element relative to the resonance. It is thus likely to fail to sufficiently lower the vibration level in the vicinity of the resonance point of the intermediate member and the corresponding high rotation-side (high frequency-side) antiresonance point.

A main object of the present disclosure is accordingly to further improve the vibration damping performance of the damper device.

The present disclosure is directed to a damper device. The damper device is configured to include an input element to which a torque from an engine is transmitted; an intermediate element; an output element; a first elastic body arranged to transmit a torque between the input element and the intermediate element; and a second elastic body arranged to transmit a torque between the intermediate element and the output element. The damper device further includes a rotary inertia mass damper that includes a mass body rotating in accordance with relative rotation between the input element and the output element and that is arranged between the input element and the output element to be parallel to a torque transmission path including the first elastic body, the intermediate element and the second elastic body; and an attenuation mechanism configured to attenuate resonance of the intermediate element.

The damper device of this aspect enables a plurality of natural frequencies (resonance frequencies) to be set with regard to the torque transmission path including the intermediate element in the state that deflections of the first elastic body and the second elastic body are allowed and enables resonance of the intermediate element to occur when the rotation speed of the input element reaches a rotation speed corresponding to one of the plurality of natural frequencies. The damper device of this aspect is thus capable of setting two antiresonance points where the vibration transmitted from the input element to the output element via the torque transmission path and the vibration transmitted from the input element to the output element via the rotary inertia mass damper are theoretically cancelled out each other. Making the frequencies of the two antiresonance points closer to the frequency of the vibration (resonance) that is to be attenuated by the damper device accordingly improves the vibration damping performance of the damper device. Furthermore, the damper device of this aspect includes the attenuation mechanism configured to attenuate the resonance of the intermediate element. This suppresses an increase in amplitude of the resonance of the intermediate element and effectively lowers the vibration level in the vicinity of a resonance point of the intermediate element and a corresponding antiresonance point by an inertia torque transmitted from the rotary inertia mass damper to the output element. As a result, this configuration further improves the vibration damping performance of the damper device.

### BRIEF DESCRIPTION OF DRAWINGS

FIG. 1 is a schematic configuration diagram illustrating a starting device including a damper device of the present disclosure;

FIG. 2 is a sectional view illustrating the starting device shown in FIG. 1;

FIG. 3 is an enlarged sectional view illustrating an attenuation mechanism included in the damper device of the present disclosure;

FIG. 4 is a front view illustrating a friction member of the attenuation mechanism;

FIG. 5 is a front view illustrating an urging member of the attenuation mechanism;

FIG. 6 is a main-part enlarged sectional view illustrating a rotary inertia mass damper included in the damper device of the present disclosure;

FIG. 7(a) and FIG. 7(b) are diagrams illustrating relationships between rotation speed of an engine and torque fluctuation T_{Fluc} of an output element of the damper device shown in FIG. 1 and the like;

FIG. 8 is an enlarged sectional view illustrating another damper device of the present disclosure;

FIG. 9 is an enlarged sectional view illustrating another damper device of the present disclosure;

FIG. 10 is an enlarged sectional view illustrating another damper device of the present disclosure;

FIG. 11 is a schematic configuration diagram illustrating a starting device including another damper device of the present disclosure;

FIG. 12 is a schematic configuration diagram illustrating a starting device including another damper device of the present disclosure;

FIG. 13 is a schematic configuration diagram illustrating a starting device including another damper device of the present disclosure; and

FIG. 14 is a schematic configuration diagram illustrating a starting device including another damper device of the present disclosure.

### DESCRIPTION OF EMBODIMENTS

Embodiments of the present disclosure are described below with reference to drawings.

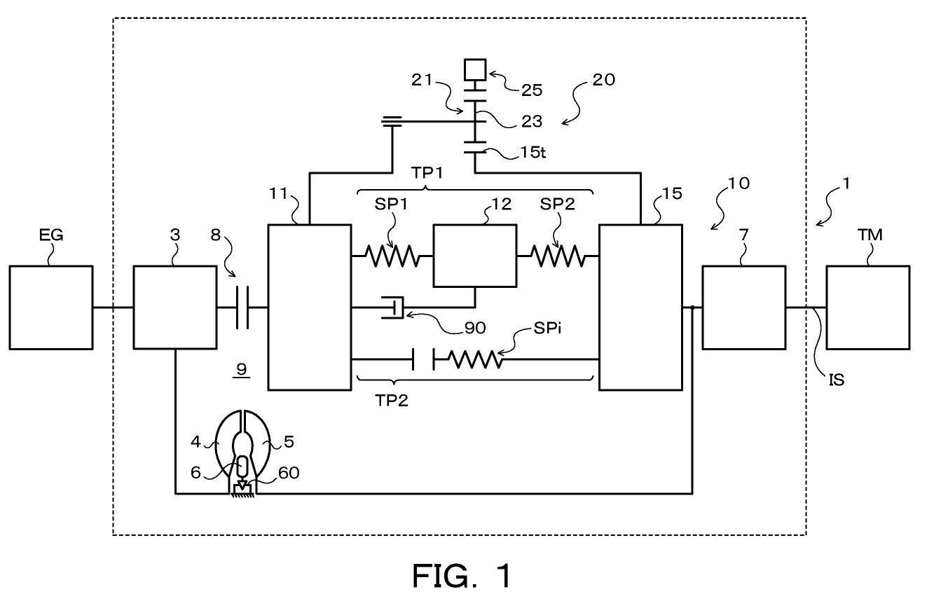

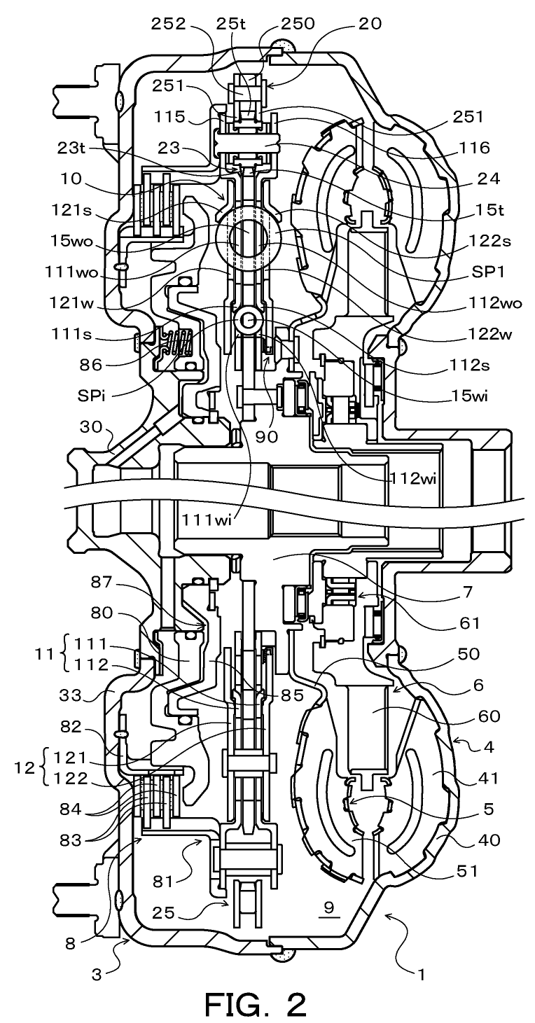

FIG. 1 is a schematic configuration diagram illustrating a starting device 1 including a damper device 10 of the present disclosure. FIG. 2 is a sectional view illustrating the starting device 1. The starting device 1 shown in these drawings is mounted on a vehicle equipped with an engine (internal combustion engine) EG as a driving device and includes, in addition to the damper device 10, for example, a front cover 3 as an input member coupled with a crankshaft of the engine EG to receive a torque transmitted from the engine EG; a pump impeller (input-side fluid transmission element) 4 fixed to the front cover 3; a turbine runner (output-side fluid transmission element) 5 arranged to be rotatable coaxially with the pump impeller 4; a damper hub 7 as an output member coupled with the damper device 10 and fixed to an input shaft IS of a transmission TM, which is either an automatic transmission (AT) or a continuously variable transmission (CVT) ; and a lockup clutch 8.

In the description below, an “axial direction” basically denotes an extending direction of a center axis (axial center) of the starting device 1 or the damper device 10, unless otherwise specified. A “radial direction” basically denotes a radial direction of the starting device 1, the damper device 10 or a rotational element of the damper device 10 or the like or more specifically an extending direction of a straight line extended from the center axis of the starting device 1 or the damper device 10 in a direction perpendicular to the center axis (in a radial direction), unless otherwise specified. A “circumferential direction” basically denotes a circumferential direction of the starting device 1, the damper device 10 or the rotational element of the damper device 10 or the like, or, in other words, a direction along a rotating direction of the rotational element, unless otherwise specified.

As shown in FIG. 2, the pump impeller 4 includes a pump shell 40 closely fixed to the front cover 3 to define a fluid chamber 9 which hydraulic oil flows in; and a plurality of pump blades 41 placed on an inner surface of the pump shell 40. As shown in FIG. 2, the turbine runner 5 includes a turbine shell 50; and a plurality of turbine blades 51 placed on an inner surface of the turbine shell 50. An inner circumferential portion of the turbine shell 50 is fixed to the damper hub 7 by means of a plurality of rivets. The pump impeller 4 and the turbine runner 5 are opposed to each other, and a stator 6 is coaxially arranged between the pump impeller 4 and the turbine runner 5 to rectify the flow of the hydraulic oil (working fluid) from the turbine runner 5 to the pump impeller 4. The stator 6 includes a plurality of stator blades 60, and the rotating direction of the stator 6 is set to only one direction by a one-way clutch 61. The pump impeller 4, the turbine runner 5 and the stator 6 form a torus (annular flow path) to circulate the hydraulic oil and serves as a torque converter (fluid transmission device) having a torque amplification function. The stator 6 and the one-way clutch 61 may be omitted from the starting device 1, and the pump impeller 4 and the turbine runner 5 may serve as fluid coupling.

The lockup clutch 8 is configured as a hydraulic multiple disc clutch to establish and release lockup that couples the front cover 3 with the damp hub 7 via the damper device 10. The lockup clutch 8 includes a lockup piston 80 supported to be movable in the axial direction by a center piece 30 that is fixed to the front cover 3; a clutch drum 81; a ring-shaped clutch hub 82 fixed to an inner surface of a side wall portion 33 of the front cover 3 such as to be opposed to the lockup piston 80; a plurality of first frictional engagement plates (friction plates having friction materials on respective surfaces thereof) 83 fit in a spline formed in an inner circumference of the clutch drum 81; and a plurality of second frictional engagement plates (separator plates) 84 fit in a spline formed in an outer circumference of the clutch hub 82.

The lockup clutch 8 also includes a ring-shaped flange member (oil chamber-defining member) 85 mounted to the center piece 30 of the front cover 3 such as to be located on the opposite side to the front cover 3 relative to the lockup piston 80, i.e., to be located on the damper device 10-side and the turbine runner 5-side of the lockup piston 80; and a plurality of return springs 86 placed between the front cover 3 and the lockup piston 80. As illustrated, the lockup piston 80 and the flange member 85 define an engagement oil chamber 87, and hydraulic oil (engagement hydraulic pressure) is supplied from a non-illustrated hydraulic pressure controller to the engagement oil chamber 87. Increasing the engagement hydraulic pressure supplied to the engagement oil chamber 87 moves the lockup piston 80 in the axial direction to press the first frictional engagement plates 83 and the second frictional engagement plates 84 toward the front cover 3, so as to engage (fully engage or slip engage) the lockup clutch 8. The lockup clutch 8 may be configured as a hydraulic single disc clutch.

As shown in FIG. 1 and FIG. 2, the damper device 10 includes a drive member (input element) 11, an intermediate member (intermediate element) 12 and a driven member (output element) 15, as rotational elements. The damper device 10 also includes a plurality of (for example, three according to the embodiment) first springs (first elastic body) SP1 arranged to transmit the torque between the drive member 11 and the intermediate member 12; a plurality of (for example, three according to the embodiment) second springs (second elastic body) SP2 arranged to work respectively in series with the corresponding first springs SP1 and transmit the torque between the intermediate member 12 and the driven member 15; and a plurality of (for example, three according to the embodiment) inner springs (third elastic body) SPi arranged to transmit the torque between the drive member 11 and the driven member 15, as torque transmission elements (torque transmission elastic body).

More specifically, as shown in FIG. 1, the damper device 10 has a first torque transmission path TP1 and a second torque transmission path TP2 that are provided in parallel to each other between the drive member 11 and the driven member 15. The first torque transmission path TP1 is formed by the plurality of first springs SP1, the intermediate member 12 and the plurality of second springs SP2 and transmits the torque between the drive member 11 and the driven member 15 via these elements. According to the embodiment, coil springs having identical specifications (spring constants) are employed as the first springs SP1 and the second springs SP2 constituting the first torque transmission path TP1. Coil springs having different spring constants may be employed as the first springs SP1 and the second springs SP2.

The second torque transmission path TP2 is formed by the plurality of inner springs SPi and transmits the torque between the drive member 11 and the driven member 15 via the plurality of inner springs SPi working in parallel to one another. According to the embodiment, the plurality of inner springs SPi forming the second torque transmission path TP2 work in parallel to the first springs SP1 and the second springs SP2 constituting the first torque transmission path TP1, when an input torque into the drive member 11 reaches a predetermined torque (first reference value) T1 that is smaller than a torque T2 (second reference value) corresponding to a maximum torsion angle θmax of the damper device 10 and a torsion angle of the drive member 11 relative to the driven member 15 becomes equal to or larger than a predetermined angle θref. Accordingly, the damper device 10 has two-step (two-stage) damping characteristics.

According to the embodiment, linear coil springs formed from a metal material helically wound to have an axial center extended straight under no application of a load are employed as the first springs SP1, the second springs SP2 and the inner springs SPi. This configuration enables the first springs SP1, the second springs SP2 and the inner springs SPi to be more appropriately stretched and contracted along the axial center, compared with a configuration employing arc coil springs. As a result, this configuration reduces a hysteresis or more specifically a difference between a torque transmitted from the second springs SP2 and the like to the driven member 15 in the process of increasing a relative displacement between the drive member 11 (input element) and the driven member 15 (output element) and a torque transmitted from the second springs SP2 and the like to the driven member 15 in the process of decreasing the relative displacement between the drive member 11 and the driven member 15. Arc coil springs may be employed as at least any of the first springs SP1, the second springs SP2 and the inner springs SPi.

As shown in FIG. 2, the drive member 11 of the damper device 10 includes a ring-shaped first input plate member 111 that is coupled with the clutch drum 81 of the lockup clutch 8; and a ring-shaped second input plate member 112 that is coupled with the first input plate member 111 by means of a plurality of rivets such as to be opposed to the first input plate member 111. Accordingly, the drive member 11 or more specifically the first input plate member 111 and the second input plate member 112 rotate integrally with the clutch drum 81, and the front cover 3 (engine EG) and the drive member 11 of the damper device 10 are coupled with each other by engagement of the lockup clutch 8.

The first input plate member 111 includes a plurality of (for example, three according to the embodiment) outer spring placing windows 111wo that are respectively extended in an arc shape and that are placed at intervals (at equal intervals) in the circumferential direction; a plurality of (for example, three according to the embodiment) inner spring placing windows 111wi that are respectively extended in an arc shape and that are placed at intervals (at equal intervals) in the circumferential direction to be arranged on an inner side in the radial direction of the respective outer spring placing windows 111wo; a plurality of (for example, three according to the embodiment) spring support portions 111s that are extended along outer edges of the respective inner spring placing windows 111wi; a plurality of (for example, three according to the embodiment) non-illustrated outer spring contact portions; and a plurality of (for example, six according to the embodiment) non-illustrated inner spring contact portions. The respective inner spring placing windows 111wi have a circumference longer than the natural length of the inner springs SPi. Each of the outer spring contact portions of the first input plate member 111 is provided between adjacent outer spring placing windows 111wo that adjoin to each other along the circumferential direction. Additionally, the inner spring contact portions of the first input plate member 111 are provided on respective sides in the circumferential direction of each of the inner spring placing windows 111wi.

The second input plate member 112 includes a plurality of (for example, three according to the embodiment) outer spring placing windows 112wo that are respectively extended in an arc shape and that are placed at intervals (at equal intervals) in the circumferential direction; a plurality of (for example, three according to the embodiment) inner spring placing windows 112wi that are respectively extended in an arc shape and that are placed at intervals (at equal intervals) in the circumferential direction to be arranged on an inner side in the radial direction of the respective outer spring placing windows 112wo; a plurality of (for example, three according to the embodiment) spring support portions 112s that are extended along outer edges of the respective inner spring placing windows 112wi; a plurality of (for example, three according to the embodiment) non-illustrated outer spring contact portions; and a plurality of (for example, six according to the embodiment) non-illustrated inner spring contact portions. The respective inner spring placing windows 112wi have a circumference longer than the natural length of the inner springs SPi. Each of the outer spring contact portions of the second input plate member 112 is provided between adjacent outer spring placing windows 112wo that adjoin to each other along the circumferential direction. Additionally, the inner spring contact portions of the second input plate member 112 are provided on respective sides in the circumferential direction of each of the inner spring placing windows 112wi. According to the embodiment, components of an identical shape are employed as the first input plate member 111 and the second input plate member 112. This configuration reduces the number of different types of components.

The intermediate member 12 includes a ring-shaped first intermediate plate member 121 that is placed on the front cover 3-side of the first input plate member 111 of the drive member 11; and a ring-shaped second intermediate plate member 122 that is placed on the turbine runner 5-side of the second input plate member 112 of the drive member 11 and that is coupled with (fixed to) the first intermediate plate member 121 by means of a plurality of rivets. As shown in FIG. 2, the first intermediate plate member 121 and the second intermediate plate member 122 are arranged such that the first input plate member 111 and the second input plate member 112 are placed between the first and second intermediate plate members 121 and 122 in the axial direction of the damper device 10.

The first intermediate plate member 121 includes a plurality of (for example, three according to the embodiment) spring placing windows 121w that are respectively extended in an arc shape and that are placed at intervals (at equal intervals) in the circumferential direction; a plurality of (for example, three according to the embodiment) spring support portions 121s that are extended along outer edges of the respective corresponding spring placing windows 121w; and a plurality of (for example, three according to the embodiment) non-illustrated spring contact portions. Each of the spring contact portions of the first intermediate plate member 121 is provided between adjacent spring placing windows 121w that adjoin to each other along the circumferential direction. The second intermediate plate member 122 includes a plurality of (for example, three according to the embodiment) spring placing windows 122w that are respectively extended in an arc shape and that are placed at intervals (at equal intervals) in the circumferential direction; a plurality of (for example, three according to the embodiment) spring support portions 122s that are extended along outer edges of the respective corresponding spring placing windows 122w; and a plurality of (for example, three according to the embodiment) non-illustrated spring contact portions. Each of the spring contact portions of the second intermediate plate member 122 is provided between adjacent spring placing windows 122w that adjoin to each other along the circumferential direction. According to the embodiment, components of an identical shape are employed as the first intermediate plate member 121 and the second intermediate plate member 122. This configuration reduces the number of different types of components.

The driven member 15 is configured as a plate-like ring-shaped member, is placed between the first input plate member 111 and the second input plate member 112 in the axial direction, and is fixed to the damper hub 7 by means of a plurality of rivets. The driven member 15 includes a plurality of (for example, three according to the embodiment) outer spring placing windows 15wo that are respectively extended in an arc shape and that are placed at intervals (at equal intervals) in the circumferential direction; a plurality of (for example, three according to the embodiment) inner spring placing windows 15wi that are placed at intervals (at equal intervals) in the circumferential direction to be arranged on an inner side in the radial direction of the respective outer spring placing windows 15wo; a plurality of (for example, three according to the embodiment) non-illustrated outer spring contact portions; and a plurality of (for example, six according to the embodiment) non-illustrated inner spring contact portions. Each of the outer spring contact portions of the driven member 15 is provided between adjacent outer spring placing windows 15wo that adjoin to each other along the circumferential direction. The respective inner spring placing windows 15wi have a circumference corresponding to the natural length of the inner springs SPi. Additionally, the inner spring contact portions of the driven member 15 are provided on respective sides in the circumferential direction of each of the inner spring placing windows 15wi.

One first spring SP1 and one second spring SP2 are arranged to be paired (i.e., to work in series) in the outer spring placing windows 111wo of the first input plate member 111, the outer spring placing windows 112wo of the second input plate member 112, and the outer spring placing windows 15wo of the driven member 15. In the mounted state of the damper device 10, each of the outer spring contact portions of the first and the second input plate members 111 and 112 and the outer spring contact portions of the driven member 15 is located between the first spring SP1 and the second spring SP2 that are placed in different outer spring placing windows 15wo, 111wo and 112wo not to be paired (i.e., not to work in series) and is arranged to contact with ends of the first spring SP1 and the second spring SP2.

Furthermore, each of the spring contact portions of the first and the second intermediate plate members 121 and 122 is placed between the first spring SP1 and the second spring SP2 that are placed in identical outer spring placing windows 15wo, 111wo and 112wo to be paired and is arranged to contact with ends of the first spring SP1 and the second spring SP2. The first spring SP1 and the second spring SP2 that are placed indifferent outer spring placing windows 15wo, 111wo and 112wo and that are not paired (i.e., not to work in series) are placed in the spring placing windows 121w and 122w of the first and the second intermediate plate members 121 and 122. Additionally, the first spring SP1 and the second spring SP2 that are not paired are supported (guided) from outer side in the radial direction by the spring support portions 121s of the first intermediate plate member 121 on the front cover 3-side and are also supported (guided) from outer side in the radial direction by the spring support portions 122s of the second intermediate plate member 122 on the turbine runner 5-side.

The first springs SP1 and the second springs SP2 are thus arranged alternately in the circumferential direction of the damper device 10. One end of each of the first springs SP1 contacts with the corresponding outer spring contact portions of the first and the second input plate members 111 and 112 (drive member 11), and the other end of each of the first springs SP1 contacts with the corresponding spring contact portions of the first and the second intermediate plate members (intermediate member 12). One end of each of the second springs SP2 contacts with the corresponding spring contact portions of the first and the second intermediate plate members (intermediate member 12), and the other end of each of the second springs SP2 contacts with the corresponding outer spring contact portion of the driven member 15.

As a result, the first spring SP1 and the second spring SP2 that are paired are coupled in series via the corresponding spring contact portions of the first and the second intermediate plate members (intermediate member 12) between the drive member 11 and the driven member 15. In the damper device 10, this configuration reduces the stiffness of the elastic body serving to transmit the torque between the drive member 11 and the driven member 15, i.e., reduces a combined spring constant of the first and the second springs SP1 and SP2. According to the embodiment, the plurality of first springs SP1 and the plurality of second springs SP2 are respectively arranged on an identical circumference, such that the distances between the axial center of the starting device 1 or the damper device 10 and the axial centers of the respective first springs SP1 and the distances between the axial center of the starting device 1 or the like and the axial centers of the respective second springs SP2 are equal to each other.

The inner spring SPi is placed in each of the inner spring placing windows 15wi of the driven member 15. In the mounted state of the damper device 10, each of the inner spring contact portions of the driven member 15 contacts with a corresponding end of the inner spring SPi. Additionally, in the mounted state of the damper device 10, a front cover 3-side lateral portion of each of the inner springs SPi is placed in a center part in the circumferential direction of the corresponding inner spring placing window 111wi of the first input plate member 111 and is supported (guided) from outside in the radial direction by the spring support portion 111s of the first input plate member 111. In the mounted state of the damper device 10, a turbine runner 5-side lateral portion of each of the inner springs SPi is placed in a center part in the circumferential direction of the corresponding inner spring placing window 112w i of the second input plate member 112 and is supported (guided) from outside in the radial direction by the spring support portion 112s of the second input plate member 112.

As shown in FIG. 2, each of the inner springs SPi is accordingly placed in an inner circumferential region in the fluid chamber 9 and is supported by the first spring SP1 and the second spring SP2. As a result, this configuration further shortens the axial length of the damper device 10 and thereby the axial length of the starting device 1. One end of each of the inner springs SPi contacts with one of the inner spring contact portions provided on respective sides of the corresponding inner spring placing windows 111wi and 112w i of the first and the second input plate members 111 and 112, when the input torque (drive torque) into the drive member 11 or the torque (driven torque) applied from the axel side to the driven member 15 reaches the torque T1 and the torsion angle of the drive member 11 relative to the driven member 15 becomes equal to or larger than the predetermined angle θref.

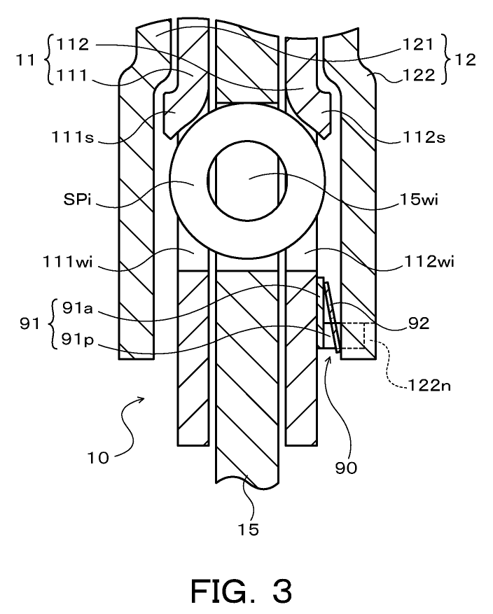

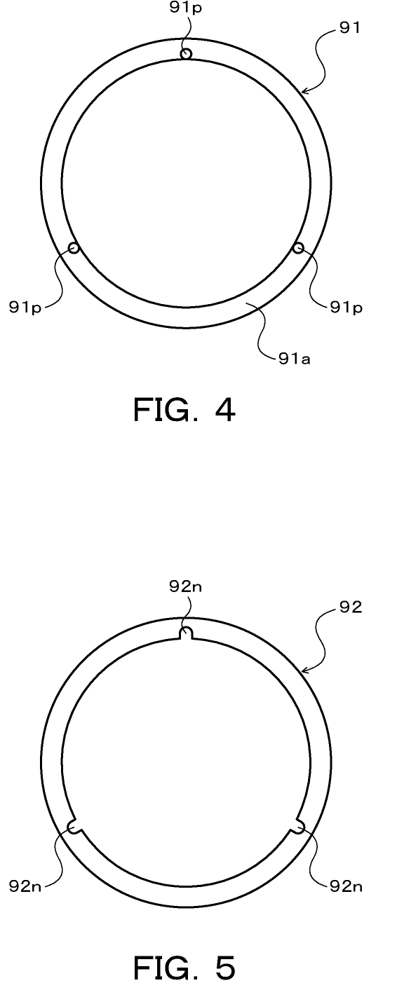

Additionally, as shown in FIG. 2 and FIG. 3, the damper device 10 includes an attenuation mechanism 90 configured to generate a frictional force between the drive member 11 and the intermediate member 12. According to the embodiment, the attenuation mechanism 90 includes a ring-shaped friction member 91 and a ring-shaped urging member 92 that are placed between an inner circumferential portion of the second input plate member 112 of the drive member 11 (portion on an inner circumference side of the inner spring placing windows 112wi) and an inner circumferential portion of the second intermediate plate member 122 of the intermediate member 12 in the axial direction. The friction member 91 is made of, for example, a resin and has a flat plate-like, ring-shaped washer portion 91a and a plurality of projections 91p protruded in the axial direction from one surface of the washer portion 91a and arranged at intervals in the circumferential direction (for example, three projections 91p arranged at intervals of 120 degrees according to the embodiment), as shown in FIG. 3 and FIG. 4. According to the embodiment, the urging member 92 is a ring-shaped disc spring made of a metal and has a plurality of cuts 92n extended from its inner circumferential edge outward in the radial direction and arranged at intervals in the circumferential direction (the same number of cuts 92n as the number of the projections 91p, for example, three cuts 92n arranged at intervals of 120 degrees according to the embodiment), as shown in FIG. 5. At least one projection 91p and at least one cut 92n need to be provided in the friction member 91 or in the urging member 92.

Each of the projections 91p of the friction member 91 is fit in a corresponding cut (or hole) 122n formed in the inner circumferential portion of the second intermediate plate member 122 of the intermediate member 12, so that the friction member 91 is made to integrally rotate with the second intermediate plate member 122, i.e., with the intermediate member 12. Additionally, the urging member 92 is placed between the inner circumferential portion of the second intermediate plate member 122 and a rear surface of the washer portion 91a of the friction member 91 to be crushed by a predetermined amount, such that a corresponding projection 91p of the friction member 91 is loosely fit in each cut 92n, and is made to integrally rotate with the intermediate member 12. The friction member 91 is accordingly urged by the urging member 92 from the second intermediate plate member 122-side of the intermediate member 12 toward the second input plate member 112-side of the drive member 11. A surface of the washer portion 91a on the opposite side to the projections 91p is pressed against the inner circumferential portion of the second input plate member 112. A frictional force can thus be generated between the drive member 11 and the intermediate member 12, accompanied with relative rotation between the drive member 11 and the intermediate member 12.

The damper device 10 also includes a non-illustrated stopper configured to restrict the relative rotation between the drive member 11 and the driven member 15. The stopper restricts the relative rotation between the drive member 11 and the driven member 15 when the input torque into the drive member 11 reaches the torque T2 corresponding to the maximum torsion angle emax of the damper device 10. This results in restricting all deflections of the first springs SP1, the second springs SP2 and the inner springs SPi.

As shown in FIG. 1 and FIG. 2, the damper device 10 additionally includes a rotary inertia mass damper 20 that is arranged parallel to both the first torque transmission path TP1 including the plurality of first springs SP1, the intermediate member 12 and the plurality of second springs SP2 and the second torque transmission path TP2 including the plurality of inner springs SPi. According to the embodiment, the rotary inertia mass damper 20 includes a single pinion-type planetary gear 21 that is placed between the drive member 11 as the input element of the damper device 10 and the driven member 15 as the output element.

According to the embodiment, the planetary gear 21 is comprised of the driven member 15 that has external teeth 15t on its outer circumference and that serves as a sun gear, the first and the second input plate members 111 and 112 that rotatably support a plurality of (for example, three according to the embodiment) pinion gears 23 respectively engaging with the external teeth 15t and that serve as a carrier, and a ring gear 25 that has internal teeth 25t engaging with the respective pinion gears 23 and that is arranged concentrically with the driven member 15 (external teeth 15t) as the sun gear. Accordingly, the driven member 15 as the sun gear, the plurality of pinion gears 23, and the ring gear 25 at least partly overlap with the first and the second springs SP1 and SP2 (and the inner springs SPi) in the fluid chamber 9 in the axial direction when being viewed in the radial direction of the damper device 10.

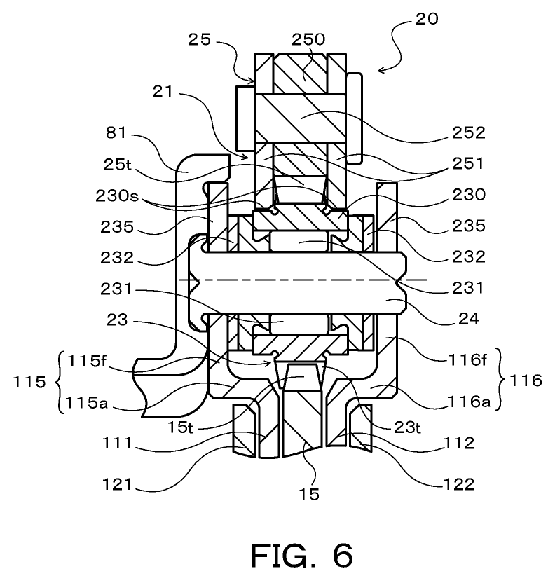

As shown in FIG. 2 and FIG. 6, the external teeth 15t are formed at a plurality of locations determined at intervals (at equal intervals) in the circumferential direction in an outer circumferential surface of the driven member 15. Accordingly, the external teeth 15t are located on the outer side in the radial direction of the outer spring placing windows 15wo and the inner spring placing windows 15wi, that is, on the outer side in the radial direction of the first springs SP1, the second springs SP2 and the inner springs SPi serving to transmit the torque between the drive member 11 and the driven member 15. The external teeth 15t may be formed around the entire outer circumference of the driven member 15.

As shown in FIG. 2, the first input plate member 111 constituting the carrier of the planetary gear 21 includes a plurality of (for example, three according to the embodiment) pinion gear support portions 115 that are arranged at intervals (at equal intervals) in the circumferential direction on the outer side in the radial direction of the outer spring placing windows 111wo (outer spring contact portions). Similarly, as shown in FIG. 2, the second input plate member 112 constituting the carrier of the planetary gear 21 includes a plurality of (for example, three according to the embodiment) pinion gear support portions 116 that are arranged at intervals (at equal intervals) in the circumferential direction on the outer side in the radial direction of the outer spring placing windows 112wo (outer spring contact portions).

As shown in FIG. 6, each of the pinion gear support portions 115 of the first input plate member 111 includes an arc-shaped protruded portion 115a that is formed to be protruded toward the front cover 3-side, and an arc-shaped flange portion 115f that is extended outward in the radial direction from an end of the protruded portion 115a. Each of the pinion gear support portions 116 of the second input plate member 112 includes an arc-shaped protruded portion 116a that is formed to be protruded toward the turbine runner 5-side, and an arc-shaped flange portion 116f that is extended outward in the radial direction from an end of the protruded portion 116a.

Each of the pinion gear support portions 115 (flange portions 115f) of the first input plate member 111 is opposed in the axial direction to the corresponding pinion gear support portion 116 (flange portion 116f) of the second input plate member 112, and the paired flange portions 115f and 116f support an end of a pinion shaft 24 inserted in the pinion gear 23. According to the embodiment, the pinion gear support portions 115 (flange portions 115f) of the first input plate member 111 are respectively clamped to the clutch drum 81 of the lockup clutch 8 by means of rivets. Furthermore, according to the embodiment, the first intermediate plate member 121 constituting the intermediate member 12 is aligned by inner circumferential surfaces of the protruded portions 115a of the pinion gear support portions 115. The second intermediate plate member 122 constituting the intermediate member 12 is aligned by inner circumferential surfaces of the protruded portions 116a of the pinion gear support portions 116.

As shown in FIG. 6, the pinion gear 23 of the planetary gear 21 includes a ring-shaped gear main body 230 that has gear teeth (external teeth) 23t on its outer circumference; a plurality of needle bearings 231 that are placed between an inner circumferential surface of the gear main body 230 and an outer circumferential surface of the pinion shaft 24; and a pair of spacers 232 that are fit on respective ends of the gear main body 230 to restrict the movements of the needle bearings 231 in the axial direction. As shown in FIG. 6, the gear main body 230 of the pinion gear 23 includes ring-shaped radial direction support portions 230s that are protruded on respective sides in the axial direction of the gear teeth 23t on the inner circumferential side of bottoms of the gear teeth 23t in the radial direction of the pinion gear 23 and that have outer circumferential surfaces in a cylindrical shape. The outer circumferential surface of each spacer 232 is formed to have a diameter that is equal to the diameter of the radial direction support portion 230s or that is smaller than the diameter of the radial direction support portion 230s.

The plurality of pinion gears 23 are rotatably supported by the first and the second input plate members 111 and 112 (pinion gear support portions 115 and 116) serving as the carrier to be arrayed at intervals (at equal intervals) in the circumferential direction. Washers 235 are placed between side surfaces of the respective spacers 232 and the pinion gear support portions 115 and 116 (flange portions 115f and 116f) of the first and second input plate members 111 and 112. Gaps are formed between respective side surfaces of the gear teeth 23t of the pinion gears 23 and the pinion gear support portions 115 and 116 (flange portions 115f and 116f) of the first and second input plate members 111 and 112 in the axial direction, as shown in FIG. 6.

The ring gear 25 of the planetary gear 21 includes a ring-shaped gear main body 250 that has internal teeth 25t on its inner circumference; two side plates 251 that are respectively formed in an annular shape; and a plurality of rivets 252 that are provided to fix the respective side plates 251 to respective side surfaces in the axial direction of the gear main body 250. The gear main body 250, the two side plates 251 and the plurality of rivets 252 are integrated to serve as an inertial mass body (mass body) of the rotary inertia mass damper 20. According to the embodiment, the internal teeth 25t is formed around the entire inner circumferential surface of the gear main body 250. The internal teeth 25t may be formed at a plurality of locations determined at intervals (at equal intervals) in the circumferential direction in the inner circumferential surface of the gear main body 250.

Each of the side plates 251 serves as a supported portion that has an inner circumferential surface of a recessed cylindrical shape and that is supported in the axial direction by the plurality of pinion gears 23 engaging with the internal teeth 25t. More specifically, the two side plates 251 are fixed to corresponding side surfaces of the gear main body 250 on the respective sides in the axial direction of the internal teeth 25t such as to be protruded to an inner side in the radial direction of the bottoms of the internal teeth 25t and to be opposed to at least the side surfaces of the gear teeth 23t of the pinion gear 23. According to the embodiment, an inner circumferential surface of each side plate 251 is located on a slightly inner side in the radial direction of tips of the internal teeth 25t as shown in FIG. 6.

When the respective pinion gears 23 are engaged with the internal teeth 25t, the inner circumferential surfaces of the respective side plates 251 are supported in the radial direction by the corresponding radial direction support portions 230s of the pinion gear 23 (gear main body 230). This configuration enables the ring gear 25 to be aligned with high accuracy relative to the axial center of the driven member 15 serving as the sun gear by the radial direction support portions 230s of the plurality of pinion gears 23 and to smoothly rotate (oscillate). When the respective pinion gears 23 are engaged with the internal teeth 25t, the inner surfaces of the respective side plates 251 are opposed to side surfaces of the gear teeth 23t of the pinion gear 23 and side surfaces of portions from the bottoms of the gear teeth 23t to the radial direction support portions 230s. The movement in the axial direction of the ring gear 25 is accordingly restricted by at least the side surfaces of the gear teeth 23t of the pinion gear 23. Additionally, gaps are formed between outer surfaces of the respective side plates 251 of the ring gear 25 and the pinion gear support portions 115 and 116 (flange portions 115f and 116f) of the first and second input plate members 111 and 112 in the axial direction, as shown in FIG. 6.

In the starting device 1 configured as described above, as understood from FIG. 1, in the state that the lockup by the lockup clutch 8 is released, the torque (power) transmitted from the engine EG to the front cover 3 is transmitted to the input shaft IS of the transmission TM through the path of the pump impeller 4, the turbine runner 5, and the damper hub 7. In the state that the lockup is established by the lockup clutch 8 of the starting device 1, on the other hand, the torque transmitted from the engine EG to the drive member 11 through the front cover 3 and the lockup clutch 8 is transmitted to the driven member 15 and the damper hub 7 via the first torque transmission path TP1 including the plurality of first springs SP1, the intermediate member 12 and the plurality of second springs SP2 and the rotary inertia mass damper 20, when the input torque is smaller than the torque T1 described above and the torsion angle of the drive member 11 relative to the driven member 15 is smaller than the predetermined angle θref. When the input torque becomes equal to or larger than the torque T1 described above, the torque transmitted to the drive member 11 is transmitted to the driven member 15 and the damper hub 7 via the first torque transmission path TP1 described above, the second torque transmission path TP2 including the plurality of inner springs SPi, and the rotary inertia mass damper 20.

When the drive member 11 is rotated (twisted) relative to the driven member 15 in the established state of the lockup (in the engaged state of the lockup clutch 8), the first springs SP1 and the second springs SP2 are deflected, and the ring gear 25 as the mass body rotates (oscillates) around the axial center accompanied with the relative rotation between the drive member 11 and the driven member 15. When the drive member 11 is rotated (swung) relative to the driven member 15, the rotation speed of the drive member 11 or more specifically the first and the second input plate members 111 and 112 as the carrier that is the input element of the planetary gear 21 becomes higher than the rotation speed of the driven member 15 as the sun gear. Accordingly, in this state, the ring gear 25 is accelerated by the function of the planetary gear 21 to be rotated at the higher rotation speed than that of the drive member 11. An inertia torque is then applied from the ring gear 25 that is the mass body of the rotary inertia mass damper 20 to the driven member 15 that is the output element of the damper device 10 via the pinion gears 23. This damps the vibration of the driven member 15. The rotary inertia mass damper 20 serves to mainly transmit the inertia torque between the drive member 11 and the driven member 15, while not transmitting the average torque.

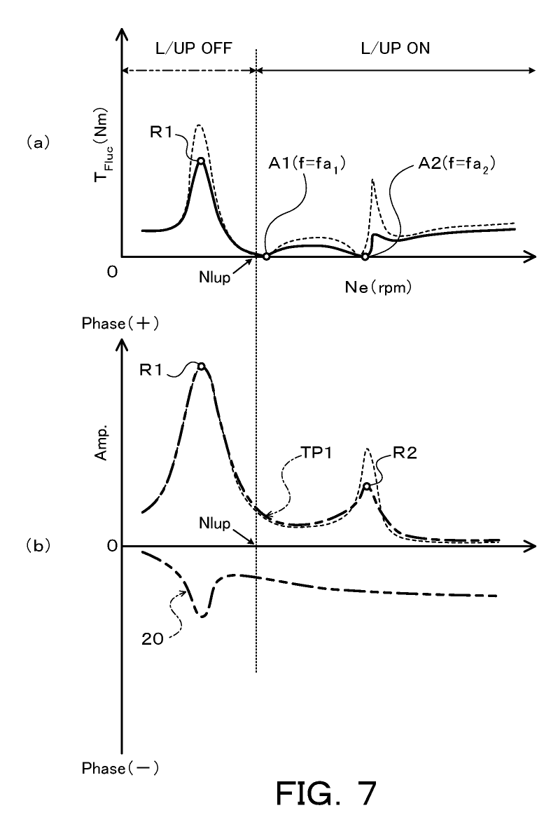

The following describes in detail the principle of damping the vibration by the damper device 10 with reference to FIG. 7.

As described above, in the damper device 10, the first and the second springs SP1 and SP2 included in the first torque transmission path TP1 and the rotary inertia mass damper 20 work in parallel until the input torque transmitted to the drive member 11 reaches the torque T1 described above. While the first and the second springs SP1 and SP2 and the rotary inertia mass damper 20 work in parallel, the torque transmitted from the first torque transmission path TP1 including the intermediate member 12 and the first and the second springs SP1 and SP2 to the driven member 15 is dependent on (proportional to) the displacement (amount of deflection, i.e., torsion angle) of the second springs SP2 placed between the intermediate member 12 and the driven member 15. The torque transmitted from the rotary inertia mass damper 20 to the driven member 15 is, on the other hand, dependent on (proportional to) a difference in angular acceleration between the drive member 11 and the driven member 15, i.e., a twice differentiated value of the displacement of the first and the second springs SP1 and SP2 between the drive member 11 and the driven member 15. On the assumption that the input torque T transmitted to the drive member 11 of the damper device 10 periodically vibrates as expressed by T=T₀sinωt (where “ω” denotes an angular frequency in the periodical fluctuation (vibration) of the input torque T), the phase of the vibration transmitted from the drive member 11 to the driven member 15 via the first torque transmission path TP1 shifts by 180 degrees from the phase of the vibration transmitted from the drive member 11 to the driven member 15 via the rotary inertia mass damper 20.

Furthermore, in the damper device 10 including the intermediate member 12, two natural frequencies (resonance frequencies) may be set in the state that the deflection of the first and the second springs SP1 and SP2 is allowed and the inner springs SPi is not deflected. More specifically, on the assumption that transmission of the torque from the engine EG to the drive member 11 is started in the established state of the lockup by the lockup clutch 8, resonance occurs due to vibrations of the drive member 11 and the driven member 15 in the opposite phases or resonance of mainly the transmission occurs between the drive member 11 and a non-illustrated driveshaft (first resonance, as shown by a resonance point R1 in FIG. 7(b)) in the first torque transmission path TP1, in the state that the deflection of the first and the second springs SP1 and SP2 is allowed and the inner springs SPi is not deflected.

The intermediate member 12 of the first torque transmission path TP1 is formed in a ring shape. In the course of transmission of the torque from the engine EG to the drive member 11, the inertial force applied to the intermediate member 12 becomes larger than the resistance force interfering with the vibration of the intermediate member 12 (mainly, frictional force caused by the centrifugal force applied to the rotating intermediate member 12). A damping ratio ζ of the intermediate member 12 that vibrates accompanied with transmission of the torque from the engine EG to the drive member 11 accordingly becomes less than a value 1. The damping ratio ζ of the intermediate member 12 in a single-degree-of-freedom system is expressed by ζ=C/{2·√[J₂·(k₁+k₂)]}. Herein “J₂” denotes a moment of inertia of the intermediate member 12; “k₁” denotes a combined spring constant of the plurality of first springs SP1 working in parallel between the drive member 11 and the intermediate member 12; “k₂” denotes a combined spring constant of the plurality of second springs SP2 working in parallel between the intermediate member 12 and the driven member 15; and “C” denotes a damping force (resistance force) per unit rate of the intermediate member 12 that interferes with the vibration of the intermediate member 12. Accordingly, the damping ratio ζ of the intermediate member 12 is determined, based on at least the moment J₂ of inertia of the intermediate member 12 and the stiffnesses k₁ and k₂ of the first and the second springs SP1 and SP2.

Additionally, the above damping force C may be determined as follows. When a displacement x of the intermediate member 12 is given by x=A·sin (ω₁₂·t), a lost energy Sc by the above damping force C is expressed as Sc=π·C·A²·ω₁₂ (where “A” denotes an amplitude and “ω₁₂” denotes a vibration frequency of the intermediate member 12). When the displacement x of the intermediate member 12 is given by x=A·sin (ω₁₂·t), a lost energy Sh by the hysteresis H in one cycle of vibration of the intermediate member 12 is expressed as Sh=2·H·A. On the assumption that the lost energy Sc by the damping force C is equal to the lost energy Sh by the hysteresis, the above damping force is expressed as C=(2·H)/(π·A·ω₁₂).

A natural frequency f₁₂ of the intermediate member 12 in the single-degree-of-freedom system is expressed as f₁₂=1/2π·√{(k₁+k₂)/J₂}. Forming the intermediate member 12 in the ring shape provides a relatively large moment of inertia J₂, so that the intermediate member 12 has a relatively small natural frequency f₁₂. As shown in FIG. 7, resonance of the intermediate member 12 accordingly occurs due to the vibration of the intermediate member 12 in the opposite phase to the phases of the vibrations of both the drive member 11 and the driven member 15 (second resonance, as shown by a resonance point R2 in FIG. 7(b)) in the first torque transmission path TP1, at a stage when a rotation speed Ne of the engine EG (rotation speed of the drive member 11) becomes rather higher than a rotation speed corresponding to the frequency at the resonance point R1 (and the frequency of an antiresonance point A1 described later) in the state that the deflection of the first and the second springs SP1 and SP2 is allowed and the inner springs SPi is not deflected.

The amplitude of the vibration transmitted from the first torque transmission path TP1 (second springs SP2) to the driven member 15 changes from a decrease to an increase before the rotation speed Ne of the engine EG (rotation speed of the drive member 11) reaches a relatively low rotation speed corresponding to the natural frequency of the intermediate member 12, as shown by a one dot chain-line curve in FIG. 7(b). The amplitude of the vibration transmitted from the rotary inertia mass damper 20 to the driven member 15, on the other hand, gradually increases with an increase in rotation speed of the engine EG (rotation speed of the drive member 11), as shown by a two dot chain-line curve in FIG. 7(b). Accordingly, in the damper device 10, due to the presence of the intermediate member 12, two peaks or two resonance points (R1 and R2) appear in the torque transmitted via the first torque transmission path TP1, so that two antiresonance points A1 and A2 where a vibration amplitude Θ₃ of the driven member 15 is theoretically zero, may be set as shown by a solid line curve in FIG. 7(a). Making the frequencies of the two antiresonance points A1 and A2 closer to the frequency of the vibration (resonance) that is to be attenuated by the damper device 10 accordingly improves the vibration damping performance of the damper device.

An equation of motion given as Expression (1) may be established in a vibration system including the damper device 10 of the embodiment in the state that the torque is transmitted from the engine EG to the drive member 11 by establishment of the lockup and that the inner springs SPi are not deflected. In Expression (1), “J₁” denotes the moment of inertia of the drive member 11; “J₂” denotes the moment of inertia of the intermediate member 12 as described above; “J₃” denotes the moment of inertia of the driven member 15; and “Jᵢ” denotes the moment of inertia of the ring gear 25 that is the mass body of the rotary inertia mass damper 20. Furthermore, “θ₁” denotes the torsion angle of the drive member 11; “θ₂” denotes the torsion angle of the intermediate member 12; “θ₃” denotes the torsion angle of the driven member 15; and “λ” denotes the gear ratio (pitch circle diameter of the external teeth 15t (sun gear)/pitch circle diameter of the internal teeth 25t of the ring gear 25) of the planetary gear 21 constituting the rotary inertia mass damper 20, i.e., the ratio of the rotation speed of the ring gear 25 as the mass body to the rotation speed of the driven member 15.

$$[ Math . 1 ]$$

$$[ \begin{matrix}{J}_{1} + {J}_{i} \cdot {( 1 + λ )}^{2} & 0 & - {J}_{i} \cdot λ \cdot ( 1 + λ ) \\ 0 & {J}_{2} & 0 \\ - {J}_{i} \cdot λ \cdot ( 1 + λ ) & 0 & {J}_{1} + {J}_{i} + \ddot{λ}\end{matrix} ] [ \begin{matrix}{\ddot{θ}}_{1} \\ {\ddot{θ}}_{2} \\ {\ddot{θ}}_{3}\end{matrix} ] + [ \begin{matrix}{k}_{1} & - {k}_{1} & 0 \\ - {k}_{1} & {k}_{1} + {k}_{2} & - {k}_{2} \\ 0 & - {k}_{2} & {k}_{2}\end{matrix} ] [ \begin{matrix}{θ}_{1} \\ {θ}_{2} \\ {θ}_{3}\end{matrix} ] = [ \begin{matrix}T \\ 0 \\ 0\end{matrix} ] \qquad ( 1 )$$

Furthermore, on the assumption that the input torque T into the drive member 11 periodically vibrates as described above and that the torsion angle θ₁ of the drive member 11, the torsion angle θ₂ of the intermediate member 12 and the torsion angle θ₃ of the driven member 15 periodically respond (vibrate) as expressed by [θ₁, θ₂, θ₃]^{T}=[Θ₁, Θ₂, Θ₃]^{T}·sinωt, an identity given by Expression (2) is obtained. In Expression (2), “Θ₁” denotes the amplitude of the vibration (vibration amplitude, i.e., maximum torsion angle) of the drive member 11 generated by transmission of the torque from the engine EG; “Θ₂” denotes the amplitude of the vibration (vibration amplitude) of the intermediate member 12 generated by transmission of the torque from the engine EG to the drive member 11; and “Θ₃” denotes the amplitude of the vibration (vibration amplitude) of the driven member 15 generated by transmission of the torque from the engine EG to the drive member 11.

$$[ Math . 2 ]$$

$$[ \begin{matrix}T \\ 0 \\ 0\end{matrix} ] = [ \begin{matrix}{k}_{1} - {ω}^{2} \{ {J}_{1} + {J}_{i} \cdot {( 1 + λ )}^{2} \} & - {k}_{1} & {ω}^{2} \cdot {J}_{i} \cdot λ \cdot ( 1 + λ ) \\ - {k}_{1} & {k}_{1} + {k}_{2} - {ω}^{2} \cdot {J}_{2} & - {k}_{2} \\ {ω}^{2} \cdot {J}_{i} \cdot λ \cdot ( 1 + λ ) & - {k}_{2} & {k}_{2} - {ω}^{2} ( {J}_{3} + {J}_{1} \cdot {λ}^{2} )\end{matrix} ] [ \begin{matrix}{Θ}_{1} \\ {Θ}_{2} \\ {Θ}_{3}\end{matrix} ] \qquad ( 2 )$$

In Expression (2), when the vibration amplitude Θ₃ of the driven member 15 is equal to 0, the damper device 10 theoretically fully damps the vibration from the engine EG and theoretically causes no vibration to be transmitted to the transmission TM, the driveshaft and the like subsequent to the driven member 15. Accordingly, a conditional expression given by Expression (3) is obtained when the identity of Expression (2) is solved with regard to the vibration amplitude Θ₃ and the vibration amplitude Θ₃ is set equal to 0. Expression (3) is a quadratic equation with regard to a square value of angular frequency ω₂ in the periodic fluctuation of the input torque T. When the square value of angular frequency ω₂ is one of two real roots (or a multiple root) of Expression (3), the vibration from the engine EG transmitted from the first torque transmission path TP1 to the driven member 15 and the vibration transmitted from the rotary inertia mass damper 20 to the driven member 15 are cancelled out each other, so that the vibration amplitude Θ₃ of the driven member 15 theoretically becomes equal to zero. From this point, it is understood that the damper device 10 is capable of setting two antiresonance points where the vibration amplitude Θ₃ of the driven member 15 theoretically becomes equal to zero.

[Math. 3]

J₂·J₁·λ(1+λ)·(ω²)²−J₁·λ(1+λ)·(k₁+k₂)·ω²+k₁·k₂=0 (3)

Two solutions ω₁ and ω₂ of Expression (3) given above may be obtained from the quadratic formula, where ω₁<ω₂. A frequency fa₁ of the low rotation-side (low frequency-side) antiresonance point A1 (hereinafter called “minimum frequency”) is expressed by Expression (4) given below, and a frequency fa₂ (fa₂>fa₁) of the high rotation-side (high frequency-side) antiresonance point A2 is expressed by Expression (5) given below. Additionally, the rotation speed Nea₁ corresponding to the minimum frequency fa₁ is expressed by Nea₁=(120/n)·fa₁, where “n” denotes the number of cylinders of the engine EG.

$$[ Math . 4 ]$$

$$\begin{matrix}{fa}_{1} = \frac{{ω}_{1}}{2 π} = \frac{1}{2 π} \sqrt{\frac{( {k}_{1} + {k}_{2} ) - \sqrt{{( {k}_{1} + {k}_{2} )}^{2} - 4 \cdot \frac{{J}_{2}}{{J}_{i}} \cdot {k}_{1} \cdot {k}_{2} \cdot \frac{1}{λ ( 1 + λ )}}}{2 \cdot {J}_{2}}} & ( 4 ) \\ {fa}_{2} = \frac{{ω}_{2}}{2 π} = \frac{1}{2 π} \sqrt{\frac{( {k}_{1} + {k}_{2} ) + \sqrt{{( {k}_{1} + {k}_{2} )}^{2} - 4 \cdot \frac{{J}_{2}}{{J}_{i}} \cdot {k}_{1} \cdot {k}_{2} \cdot \frac{1}{λ ( 1 + λ )}}}{2 \cdot {J}_{2}}} & ( 5 )\end{matrix}$$

According to the embodiment, the combined spring constant k₁ of the plurality of first springs SP1, the combined spring constant k₂ of the plurality of second springs SP2, the moment of inertia J₂ of the intermediate member 12 and the moment of inertia Jᵢ of the ring gear 25 as the mass body of the rotary inertia mass damper 20 are selected and set, based on the lockup rotation speed Nlup of the lockup clutch 8 that is a rotation speed when the engine EG and the damper device 10 are coupled with each other first time after a start of the engine EG (the lowest among a plurality of lockup rotation speeds) and the frequencies fa₁ and fa₂. This configuration further improves the vibration damping performance of the damper device 10. It is preferable that the lockup rotation speed Nlup of the lockup clutch 8 is set within a predetermined rotation speed range around the rotation speed Nea₁ corresponding to the frequency of the low rotation-side antiresonance point A1 (minimum frequency fa₁) (for example, Nea₁-500 rpm≤Nlup≤Nea₁+500 rpm). As shown in FIG. 7, the lockup rotation speed Nlup may be set to be lower than the rotation speed Nea₁ of the engine EG corresponding to the frequency of the low rotation-side antiresonance point A1, may be set equal to the rotation speed Nea₁, or may be set to a value close to the rotation speed Nea₁ (for example, Nea₁-100 rpm≤Nlup≤Nea₁+100 rpm). Furthermore, according to the embodiment, as shown in FIG. 7, the lockup rotation speed Nlup is higher than a rotation speed corresponding to the frequency of resonance at the resonance point R1 and is lower than a rotation speed corresponding to the natural frequency f₁₂ of the intermediate member 12. The resonance at the resonance point R1 (resonance at the smaller between the two natural frequencies) is virtual resonance that does not occur in the rotation speed range where the damper device 10 is used.

For example, when the moment of inertia J₂ of the intermediate member 12 is increased with a view to further reducing the minimum frequency fa₁, this reduces the damping ratio ζ of the intermediate member 12 and makes it difficult to converge the vibration of the intermediate member 12. This accordingly increases the amplitude of the resonance (R2) of the intermediate member 12 included in the first torque transmission path TP1 as shown by a broken line curve in FIG. 7(b). The increase in the amplitude of the resonance of the intermediate member 12 causes an insufficiency of the inertia torque transmitted from the rotary inertia mass damper 20 to the driven member 15 relative to the resonance. It is thus likely to fail to sufficiently lower the vibration level in the vicinity of the resonance point R2 of the intermediate member and the corresponding high rotation-side (high frequency-side) antiresonance point A2 as shown by a broken line curve in FIG. 7(a).

With a view to attenuating the resonance (R2) of the intermediate member 12, the damper device 10 is provided with the attenuation mechanism 90 configured to generate a frictional force between the drive member 11 and the intermediate member 12 as described above. As shown by a solid line curve in FIG. 7(a), this suppresses an increase in the amplitude of the resonance of the intermediate member 12 and effectively lowers the vibration level in the vicinity of the resonance point R2 and the high rotation-side antiresonance point A2 by the inertia torque transmitted from the rotary inertia mass damper 20 to the driven member 15 (as shown by the solid line curve in FIG. 7(a)). As a result, the damper device 10 further improves the vibration damping performance by appropriately selecting the dynamic friction coefficient of the friction member 91 (washer portion 91a) and the stiffness of the urging member (disc spring).

In the damper device 10 where the damping ratio ζ is smaller than the value 1 and the rotation speed corresponding to the natural frequency f₁₂ of the intermediate member 12 is higher than the lockup rotation speed Nlup, resonance of the intermediate member 12 occurs when the rotation speed of the drive member 11 becomes higher than the rotation speed Nea₁ corresponding to the frequency fa₁ of the low rotation-side (low frequency-side) antiresonance point A1. Accordingly, the damper device 10 provided with the attenuation mechanism 90 to attenuate the resonance of the intermediate member 12 more effectively lowers the vibration level in the vicinity of the resonance point R2 of the intermediate member 12 and the high rotation-side (high frequency-side) antiresonance point A2. Additionally, employing the attenuation mechanism 90 to generate the frictional force between the drive member 11 and the intermediate member 12 as described in the above embodiment suppresses a shift in the phase of the vibration transmitted from the drive member 11 to the driven member 15 via the first torque transmission path TP1 by generation of the frictional force between the drive member 11 and the intermediate member 12 and effectively attenuates the resonance of the intermediate member 12.

In the attenuation mechanism 90 of the damper device 10, the friction member 91 and the urging member 92 are placed between the second input plate member 112 of the drive member 11 and the second intermediate plate member 122 of the intermediate member 12 such as to rotate integrally with the intermediate member 12. This configuration is, however, not essential. More specifically, the friction member 91 and the urging member 92 may be placed between the second input plate member 112 of the drive member 11 and the second intermediate plate member 122 of the intermediate member 12 such as to rotate integrally with the drive member 11. In the damper device 10, the sun gear of the planetary gear 21 may be coupled with (integrated with) the drive member 11, and the driven member 15 may be configured as the carrier of the planetary gear 21.

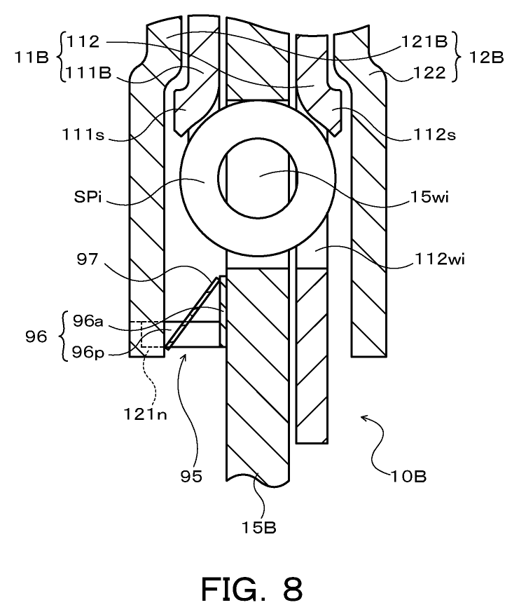

FIG. 8 is an enlarged sectional view illustrating another damper device 10B of the present disclosure. Like components to those of the damper device 10 described above among components of the damper device 10B are expressed by like reference signs, and the duplicated description is omitted. The damper device 10B shown in FIG. 8 includes an attenuation mechanism 95 configured to generate a frictional force between an intermediate member 12B and a driven member 15B and attenuate the resonance of the intermediate member 12B. As illustrated, in the damper device 10B, a first input plate member 111B of a drive member 11B excludes a portion located on the inner side in the radial direction than a portion corresponding to the inner spring placing window 111wi. A friction member 96 and an urging member 97 of the attenuation mechanism 95 are placed between an inner circumferential portion of a first intermediate plate member 121B of the intermediate member 12B and an inner circumferential portion of the driven member 15B in the axial direction.

The friction member 96 is made of, for example, a resin and has a flat plate-like, ring-shaped washer portion 96a and a plurality of projections 96p protruded in the axial direction from one surface of the washer portion 96a and arranged at intervals in the circumferential direction (for example, three projections 96p arranged at intervals of 120 degrees) as shown in FIG. 8. The urging member 97 is a ring-shaped disc spring made of a metal and has a plurality of cuts (not shown) extended from its inner circumferential edge outward in the radial direction and arranged at intervals in the circumferential direction (the same number of cuts as the number of the projections 96p, for example, three cuts arranged at intervals of 120 degrees).

Each of the projections 96p of the friction member 96 is fit in a corresponding cut (or hole) 121n formed in the inner circumferential portion of the first intermediate plate member 121B of the intermediate member 12B, so that the friction member 96 is made to integrally rotate with the first intermediate plate member 121B, i.e., with the intermediate member 12B. Additionally, the urging member 97 is placed between the inner circumferential portion of the first intermediate plate member 121B and a rear surface of the washer portion 96a of the friction member 96 to be crushed by a predetermined amount, such that a corresponding projection 96p of the friction member 96 is loosely fit in each cut, and is made to integrally rotate with the intermediate member 12B. The friction member 96 is accordingly urged by the urging member 97 from the first intermediate plate member 121B-side of the intermediate member 12B toward the driven member 15B-side. A surface of the washer portion 96a on the opposite side to the projections 96p is pressed against the inner circumferential portion of the driven member 15B. This attenuation mechanism 95 also serves to generate a frictional force between the intermediate member 12B and the driven member 15B accompanied with relative rotation between the intermediate member 12B and the driven member 15B and appropriately attenuate the resonance of the intermediate member 12B. In the attenuation mechanism 95 of the damper device 10B, the friction member 96 and the urging member 97 may be placed between the first intermediate plate member 121B of the intermediate member 12B and the driven member 15B such as to rotate integrally with the driven member 15B.

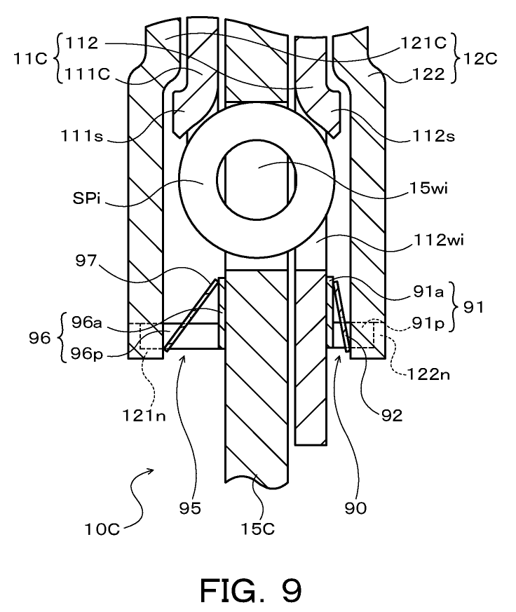

FIG. 9 is an enlarged sectional view illustrating another damper device 10C of the present disclosure. Like components to those of the damper devices 10 and 10B described above among components of the damper device 10C are expressed by like reference signs, and the duplicated description is omitted. The damper device 10C shown in FIG. 9 includes both an attenuation mechanism (first attenuation mechanism) 90 configured to generate a frictional force between a second input plate member 112 of a drive member 11C and a second intermediate plate member 122 of an intermediate member 12C and attenuate the resonance of the intermediate member 12C and an attenuation mechanism (second attenuation mechanism) 95 configured to generate a frictional force between a first intermediate plate member 121C of the intermediate member 12C and a driven member 15C and attenuate the resonance of the intermediate member 12C. In the damper device 10C, a first input plate member 111C of the drive member 11C is identical with the first input plate member 111B of the drive member 11B described above.

In this damper device 10C, a friction member (first friction member) 91 is urged by an urging member (first urging member) 92 from the second intermediate plate member 122-side of the intermediate member 12C toward the second input plate member 112-side of the drive member 11C, and a surface of a washer portion 91a on the opposite side to projections 91p is pressed against the inner circumferential portion of the second input plate member 112. A friction member (second friction member) 96 is urged by an urging member (second urging member) 97 from the first intermediate plate member 121C-side of the intermediate member 12C toward the driven member 15C-side, and a surface of a washer portion 96a on the opposite side to projections 96p is pressed against the inner circumferential portion of the driven member 15C. The damper device 10C accordingly generates frictional forces between the drive member 11C and the intermediate member 12C and between the intermediate member 12C and the driven member 15C accompanied with relative rotations of the drive member 11C, the intermediate member 12C and the drive member 15C to each other and appropriately attenuate the resonance of the intermediate member 12C. In the attenuation mechanism 90 of the damper device 10C, the friction member 91 and the urging member 92 may be placed between the second input plate member 112 of the drive member 11C and the second intermediate plate member 122 of the intermediate member 12C such as to rotate integrally with the drive member 11C. In the attenuation mechanism 95 of the damper device 10C, the friction member 96 and the urging member 97 may be placed between the first intermediate plate member 121C of the intermediate member 12C and the driven member 15C such as to rotate integrally with the driven member 15C.

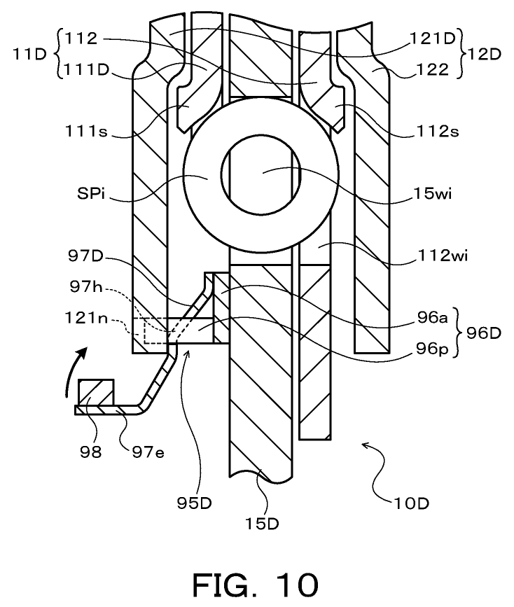

FIG. 10 is an enlarged sectional view illustrating another damper device 10D of the present disclosure. Like components to those of the damper devices 10, 10B and 10C described above among components of the damper device 10D are expressed by like reference signs, and the duplicated description is omitted. The damper device 10D shown in FIG. 10 includes an attenuation mechanism 95D configured to attenuate the resonance of an intermediate member 12D with varying a frictional force generated between the intermediate member 12D and a driven member 15D according to the rotation speed of a drive member 11D. In the damper device 10D, a first input plate member 111D of the drive member 11D is identical with the first input plate member 111B of the drive member 11B described above. A friction member 96D and an urging member 97D of the attenuation mechanism 95D are placed between an inner circumferential portion of a first intermediate plate member 121D of the intermediate member 12D and an inner circumferential portion of the driven member 15D.

The friction member 96D is made of, for example, a resin and has a flat plate-like, ring-shaped washer portion 96a and a plurality of projections 96p protruded in the axial direction from one surface of the washer portion 96a and arranged at intervals in the circumferential direction (for example, three projections 96p arranged at intervals of 120 degrees). The urging member 97D is a ring-shaped disc spring made of a metal and has a smaller inner diameter than that of the urging member 97 shown in FIG. 8. Additionally, the urging member 97D includes a plurality of extended portions 97e extended from an inner circumferential portion in the axial direction to the opposite side to an outer circumferential portion and arranged at intervals in the circumferential direction (for example, four extended portions 97e arranged at intervals of 90 degrees), and a plurality of openings 97h located on the outer side in the radial direction of the extended portions 97e and arranged at intervals in the circumferential direction (the same number of openings 97h as the number of the projections 96p, for example, three openings 97h arranged at intervals of 120 degrees). As illustrated, a mass body 98 is fixed to a radially outside surface of each of the extended portions 97e of the urging member 97D.

In the damper device 10D, each of the projections 96p of the friction member 96D is fit in a corresponding cut (or hole) 121n formed in the inner circumferential portion of the first intermediate plate member 121D of the intermediate member 12D, so that the friction member 96D is made to integrally rotate with the first intermediate plate member 121D, i.e., with the intermediate member 12D. The urging member 97D is placed between the inner circumferential portion of the first intermediate plate member 121D and a rear surface of the washer portion 96a of the friction member 96D such that a corresponding projection 96p of the friction member 96D is loosely fit in each opening 97h, and is made to integrally rotate with the intermediate member 12D. In the mounted state of the damper device 10D, an outer circumferential portion of the urging member 97D contacts with the rear surface of the washer portion 96a of the friction member 96D, and a portion of the urging member 97D on the outer side in the radial direction of each of the extended portions 97e (portion in the vicinity of the opening 97h) contacts with the inner circumferential portion of the first intermediate plate member 121D to be slightly crushed. Furthermore, the inner circumferential portion and the respective extended portions 97e of the urging member 97D and the respective mass bodies 98 are located on the inner side in the radial direction (center side) of an inner circumferential edge of the first intermediate plate member 121D and are farther away from the washer portion 96a of the friction member 96D in the axial direction of the damper device 10D than a contact of the urging member 97D with the first intermediate plate member 121D (point of support).

In the attenuation mechanism 95D having the configuration described above, when the torque is transmitted to the drive member 11D to increase the rotation speed of the drive member 11D, each of the mass bodies 98 (and the extended portion 97e) moves outward in the radial direction by the centrifugal force to approach to the washer portion 96a of the friction member 96D (as shown by a solid line arrow in FIG. 10). With an increase in rotation speed of the drive member 11D, the friction member 96D is strongly urged by the urging member 97D from the first intermediate plate member 121D-side of the intermediate member 12D toward the driven member 15D. With an increase in rotation speed of the drive member 11D, a surface of the washer portion 96a on the opposite side to the projections 96p is strongly pressed against the inner circumferential portion of the driven member 15D. Accordingly, the attenuation mechanism 95D increases the frictional force between the intermediate member 12D and the driven member 15D with an increase in rotation speed of the drive member 11D. As a result, this decreases the frictional force generated at a low rotation speed of the drive member 11D. This configuration thus extremely effectively attenuates the resonance of the intermediate member 12D, while effectively suppressing a shift in the phase of the vibration transmitted from the drive member 11D to the driven member 15D accompanied with the generation of the frictional force.

The attenuation mechanism 95D may be configured to generate a frictional force between the drive member 11D and the intermediate member 12D. The damper device 10D may be provided additionally with an attenuation mechanism configured to attenuate the resonance of the intermediate member 12D with varying a frictional force between the drive member 11D and the intermediate member 12D.

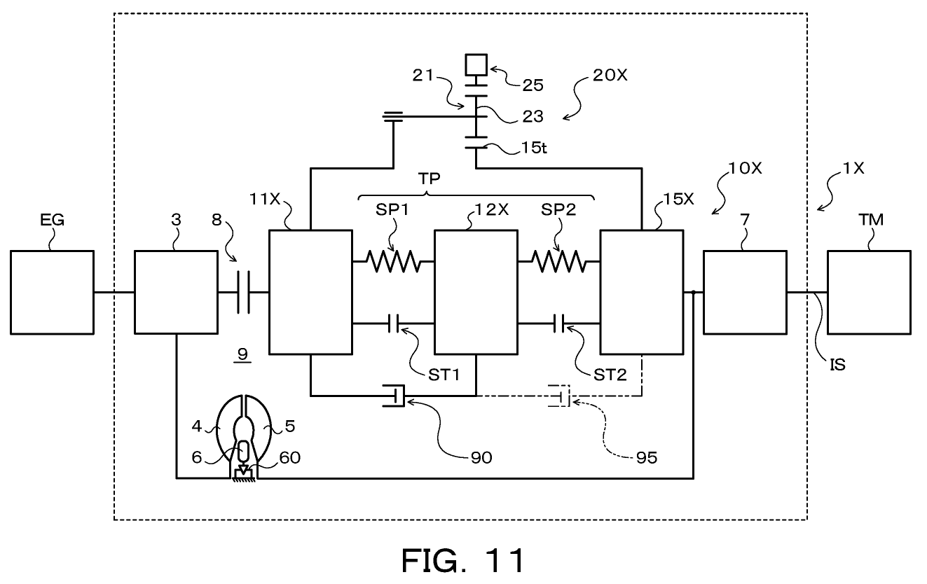

FIG. 11 is a schematic configuration diagram illustrating a starting device 1X including another damper device 10X of the present disclosure. Like components to those of the starting device 1 and the damper device 10 or the like described above among components of the starting device 1X and the damper device 10X are expressed by like reference signs, and the duplicated description is omitted.

The damper device 10X shown in FIG. 11 includes a drive member (input element) 11X, an intermediate member (intermediate element) 12X and a driven member (output element) 15X, as rotational elements. The damper device 10X also includes a plurality of first springs (first elastic body) SP1 arranged to transmit the torque between the drive member 11X and the intermediate member 12X; and a plurality of second springs (second elastic body) SP2 arranged to work respectively in series with the corresponding first springs SP1 and transmit the torque between the intermediate member 12X and the driven member 15X, as torque transmission elements (torque transmission elastic body). The plurality of first springs (first elastic body) SP1, the intermediate member 12X and the plurality of second springs (second elastic body) SP2 constitute a torque transmission path TP between the drive member 11X and the driven member 15X.

The damper device 10X further includes a rotary inertia mass damper 20X configured by a single pinion-type planetary gear 21, like the rotary inertia mass damper 20 described above. The rotary inertia mass damper 20X is provided in parallel to the torque transmission path TP between the drive member 11X and the driven member 15X. In the rotary inertia mass damper 20X, the drive member 11X rotatably supports a plurality of pinion gears 23 and serves as a carrier of the planetary gear 21. The driven member 15X has external teeth 15t and serves as a sun gear of the planetary gear 21.

The damper device 10X also includes a first stopper ST1 configured to restrict relative rotation between the drive member 11X and the intermediate member 12X, i.e., to restrict deflection of the first springs SP1; and a second stopper ST2 configured to restrict relative rotation between the intermediate member 12X and the driven member 15X, i.e., to restrict deflection of the second springs SP2. One of the first and the second stoppers ST1 and ST2 restricts the relative rotation between the drive member 11X and the intermediate member 12X or the relative rotation between the intermediate member 12X and the driven member 15X when the input torque into the drive member 11X reaches a predetermined torque T1 that is smaller than a torque T2 corresponding to a maximum torsion angle θmax of the damper device 10X and a torsion angle of the drive member 11X relative to the driven member 15X becomes equal to or larger than a predetermined angle θref. The other of the first and the second stoppers ST1 and ST2 restricts the relative rotation between the intermediate member 12X and the driven member 15X or the relative rotation between the drive member 11X and the intermediate member 12X when the input torque into the drive member 11X reaches the torque T2.

This configuration allows for deflections of the first and the second springs SP1 and SP2 until one of the first and the second stoppers ST1 and ST2 operates. When one of the first and the second stoppers ST1 and ST2 operates, deflection of one of the first and the second springs SP1 and SP2 is restricted. When both the first and the second stoppers ST1 and ST2 operate, deflections of both the first and the second springs SP1 and SP2 are restricted. Accordingly, the damper device 10X has two-step (two-stage) damping characteristics. The first stopper ST1 or the second stopper ST2 maybe configured to restrict the relative rotation between the drive member 11X and the driven member 15X.

The damper device 10X having the configuration described above is provided with an attenuation mechanism 90 configured to generate a frictional force between the drive member 11X and the intermediate member 12X and attenuate the resonance of the intermediate member 12X as shown in FIG. 11 and accordingly has similar functions and advantageous effects to those of the damper device 10 or the like described above. The damper device 10X may also be provided with an attenuation mechanism 95 configured to generate a frictional force between the intermediate member 12X and the driven member 15X and attenuate the resonance of the intermediate member 12X as shown by a two-dot chain line in the drawing. The damper device 10X maybe provided with both the attenuation mechanisms 90 and 95. Furthermore, the damper device 10X may be provided with at least one of an attenuation mechanism configured to attenuate the resonance of the intermediate member 12X with varying the frictional force between the drive member 11X and the intermediate member 12X and an attenuation mechanism configured to attenuate the resonance of the intermediate member 12X with varying the frictional force between the intermediate member 12X and the driven member 15X.

In the damper device 10X, one of the first and the second springs SP1 and SP2 may be arranged at intervals in the circumferential direction on an outer side of the other in the radial direction. For example, the plurality of first springs SP1 may be arranged at intervals in the circumferential direction in an outer circumferential-side region in the fluid chamber 9, and the plurality of second springs SP2 may be arranged at intervals in the circumferential direction on an inner side in the radial direction of the plurality of first springs SP1. In this configuration, the first springs SP1 and the second springs SP2 may be arranged to partly overlap with each other when being viewed in the radial direction. Furthermore, in the damper device 10X, the sun gear of the planetary gear 21 may be coupled with (integrated with) the drive member 11X, and the driven member 15X may be configured as the carrier of the planetary gear 21.

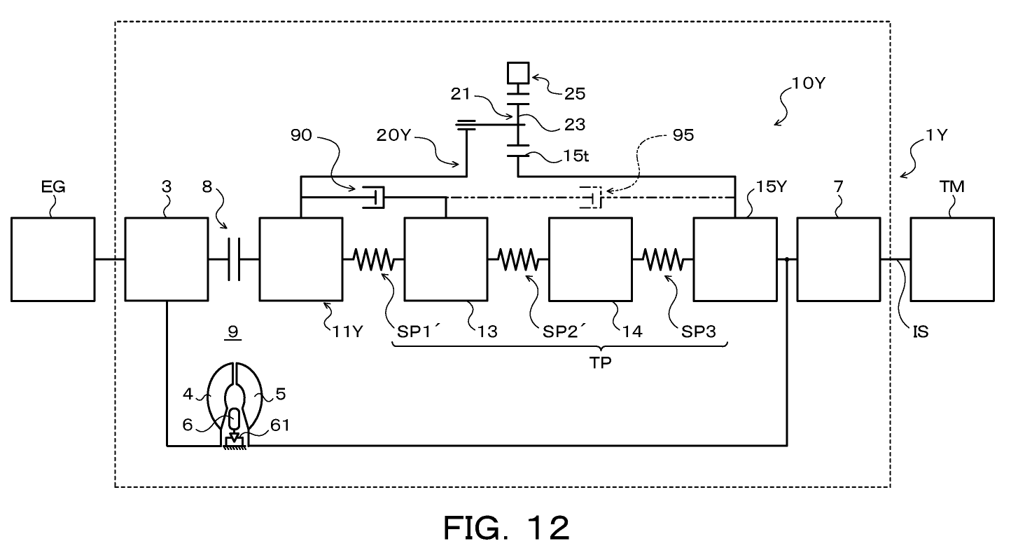

FIG. 12 is a schematic configuration diagram illustrating a starting device 1Y including another damper device 10Y of the present disclosure. Like components to those of the starting device 1 and the damper device 10 or the like described above among components of the starting device 1Y and the damper device 10Y are expressed by like reference signs, and the duplicated description is omitted.

The damper device 10Y shown in FIG. 12 includes a drive member (input element) 11Y, a first intermediate member (first intermediate element) 13, a second intermediate member (second intermediate element) 14, and a driven member (output element) 15Y, as rotational elements. The damper device 10Y also includes a plurality of first springs (first elastic body) SP1′ arranged to transmit the torque between the drive member 11Y and the first intermediate member 13; a plurality of second springs (second elastic body) SP2′ arranged to transmit the torque between the first intermediate member 13 and the second intermediate member 14; and a plurality of third springs (third elastic body) SP3 arranged to transmit the torque between the second intermediate member 14 and the driven member 15Y, as torque transmission elements (torque transmission elastic body). The plurality of first springs (first elastic body) SP1′, the first intermediate member 13, the plurality of second springs (second elastic body) SP2′, the second intermediate member 14, and the plurality of third springs SP3 constitute a torque transmission path TP between the drive member 11Y and the driven member 15Y. The damper device 10Y further includes rotary inertia mass damper 20Y that is configured by a single pinion gear-type planetary gear 21, like the rotary inertia mass damper 20 described above. The rotary inertia mass damper 20Y is provided in parallel to the torque transmission path TP between the drive member 11Y and the driven member 15Y.

In the damper device 10Y including the first and the second intermediate members 13 and 14, when the deflections of all the first to the third springs SP1′, SP2′ and SP3 are allowed, three resonances occur in the torque transmission path TP. More specifically, resonance of the entire damper device 10Y occurs in the torque transmission path TP due to vibrations of the drive member 11Y and the driven member 15Y in opposite phases when the deflections of the first to the third springs SP1′, SP2′ and SP3 are allowed. Resonance also occurs in the torque transmission path TP due to vibrations of the first and the second intermediate members 13 and 14 in opposite phases to the phases of the vibrations of both the drive member 11Y and the driven member 15Y when the deflections of the first to the third springs SP1′, SP2′ and SP3 are allowed. Resonance further occurs in the torque transmission path TP due to vibration of the first intermediate member 13 in an opposite phase to the phase of the vibration of the drive member 11Y, vibration of the second intermediate member 14 in an opposite phase to the phase of the vibration of the first intermediate member 13 and vibration of the driven member 15Y in an opposite phase to the phase of the vibration of the second intermediate member 14 when the deflections of the first to the third springs SP1′, SP2′ and SP3 are allowed. Accordingly, the damper device 10Y is capable of setting three antiresonance points where the vibration transmitted from the torque transmission path TP to the driven member 15Y and the vibration transmitted from the rotary inertia mass damper 20Y to the driven member 15Y are theoretically cancelled out each other.

The damper device 10Y is provided with an attenuation mechanism 90 configured to generate a frictional force, for example, between the drive member 11Y and the first intermediate member 13 and attenuate the resonance of the first intermediate member 13 as shown in FIG. 12 and accordingly has similar functions and advantageous effects to those of the damper device 10 or the like described above. The damper device 10Y may also be provided with an attenuation mechanism 95 configured to generate a frictional force between the first intermediate member 13 and the driven member 15Y and attenuate the resonance of the first intermediate member 13 as shown by a two-dot chain line in the drawing. The damper device 10Y may be provided with both the attenuation mechanisms 90 and 95. Furthermore, the damper device 10Y may be provided with an attenuation mechanism configured to generate a frictional force between the first and the second intermediate members 13 and 14. The damper device 10Y may also be provided with at least one of an attenuation mechanism configured to attenuate the resonance of the first intermediate member 13 with varying the frictional force between the drive member 11Y and the first intermediate member 13 and an attenuation mechanism configured to attenuate the resonance of the first intermediate member 13 with varying the frictional force between the first intermediate member 13 and the driven member 15Y. Additionally, the damper device 10Y may be provided with an attenuation mechanism configured to attenuate the resonance of the second intermediate element.

The damper device 10Y may be configured such that three or more intermediate members are included in the torque transmission path TP. In the damper device 10Y, the sun gear of the planetary gear 21 may be coupled with (integrated with) the drive member 11Y, and the driven member 15Y may be configured as the carrier of the planetary gear 21. Furthermore, in the damper device 10Y, the sun gear of the planetary gear 21 may be coupled with (integrated with), for example, the first intermediate member 13, and, for example, the first intermediate member 13 may be configured as the carrier of the planetary gear 21.

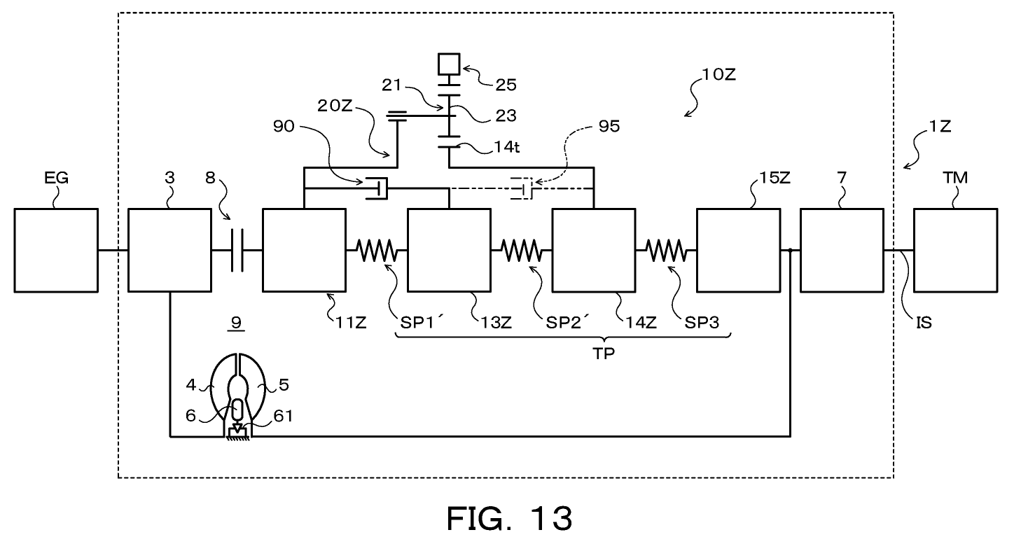

FIG. 13 is a schematic configuration diagram illustrating a starting device 1Z including another damper device 10Z of the present disclosure. Like components to those of the starting device 1 and the damper device 10 or the like described above among components of the starting device 1Z and the damper device 10Z are expressed by like reference signs, and the duplicated description is omitted.

The damper device 10Z shown in FIG. 13 includes a drive member (input element) 11Z, a first intermediate member (first intermediate element) 13Z, a second intermediate member (second intermediate element) 14Z, and a driven member (output element) 15Z, as rotational elements. The damper device 10Z also includes a plurality of first springs (first elastic body) SP1′ arranged to transmit the torque between the drive member 11Z and the first intermediate member 13Z; a plurality of second springs (second elastic body) SP2′ arranged to transmit the torque between the first intermediate member 13Z and the second intermediate member 14Z; and a plurality of third springs (third elastic body) SP3 arranged to transmit the torque between the second intermediate member 14Z and the driven member 15Z, as torque transmission elements (torque transmission elastic body). The plurality of first springs (first elastic body) SP1′, the first intermediate member 13Z, the plurality of second springs (second elastic body) SP2′, the second intermediate member 14Z, and the plurality of third springs SP3 constitute a torque transmission path TP between the drive member 11Z and the driven member 15Z.

The damper device 10Z further includes a rotary inertia mass damper 20Z configured by a single pinion-type planetary gear 21, like the rotary inertia mass damper 20 described above. The rotary inertia mass damper 20Z is provided in parallel to the first springs SP1′, the first intermediate member 13Z and the second springs SP2′ of the torque transmission path TP between the drive member 11Z and the second intermediate member 14Z. In the rotary inertia mass damper 20Z, the drive member 11Z supports a plurality of pinion gears 23 in a rotatable manner and serves as the carrier of the planetary gear 21. The second intermediate member 14Z has external teeth 14t and serves as the sun gear of the planetary gear 21. A ring gear 25 as the mass body rotates (swings) about the axial center with relative rotation between the drive member 11Z and the second intermediate member 14Z.

This damper device 10Z substantially corresponds to a configuration that the plurality of third springs SP3 working in parallel are placed between the driven member 15X and the input shaft IS of the transmission TM in the damper device 10X shown in FIG. 11. In the damper device 10Z, the rotary inertia mass damper 20Z is provided in parallel to the first and the second springs SP1′ and SP2′ and the first intermediate member 13Z. Accordingly, the damper device 10Z enables two (a plurality of) natural frequencies to be set with regard to a torque transmission path from the drive member 11Z to the second intermediate member 14Z when deflections of at least the first and the second springs SP1′ and SP2′ are allowed and enables resonance (second resonance) of the first intermediate member 13Z to occur on the higher rotation side (higher frequency side) than the first resonance. As a result, the damper device 10Z is capable of setting two antiresonance points where the vibration amplitude of the driven member 15Z is theoretically equal to zero.

The damper device 10Z having the configuration described above is provided with an attenuation mechanism 90 configured to generate a frictional force, for example, between the drive member 11Z and the first intermediate member 13Z and attenuate the resonance of the first intermediate member 13Z as shown in FIG. 13 and accordingly has similar functions and advantageous effects to those of the damper device 10 or the like described above. The damper device 10Z may also be provided with an attenuation mechanism 95 configured to generate a frictional force between the first intermediate member 13Z and the second intermediate member 14Z and attenuate the resonance of the first intermediate member 13Z as shown by a two-dot chain line in the drawing. The damper device 10Z may be provided with both the attenuation mechanisms 90 and 95. Furthermore, the damper device 10Z may be provided with at least one of an attenuation mechanism configured to attenuate the resonance of the first intermediate member 13Z with varying the frictional force between the drive member 11Z and the first intermediate member 13Z and an attenuation mechanism configured to attenuate the resonance of the first intermediate member 13Z with varying the frictional force between the first intermediate member 13Z and the second intermediate member 14Z.

The damper device 10Z is especially preferably used in combination with a transmission TM for rear wheel drive. In the transmission TM for rear wheel drive that has a large length from an end of an input shaft IS (end on the starting device 1Z-side) to an end of a non-illustrated output shaft of the transmission TM (end on wheel-side), the input shaft IS coupled with the driven member 15Z of the damper device 10Z and the output shaft (and additionally a non-illustrated intermediate shaft of the transmission TM) have lowered stiffnesses. The natural frequency (resonance frequency) determined according to the moments of inertia of these shaft members is decreased (lowered) by the effect of the moment of inertia of the entire rotary inertia mass damper 20Z. Resonance that is expected to occur at a high rotation speed of the drive member 11 (engine EG) is thus likely to occur apparently in a low rotation range. The configuration that the rotary inertia mass damper 20Z is coupled with the drive member 11Z and the second intermediate member 14Z of the damper device 10Z, however, causes the third springs SP3 to be placed between the rotary inertia mass damper 20Z and the input shaft IS of the transmission TM coupled with the driven member l5Z and thereby substantially separates the rotary inertia mass damper 20Z from the input shaft IS of the transmission TM coupled with the driven member 15Z. This configuration extremely effectively reduces the effect of the moment of inertia of the entire rotary inertia mass damper 20Z on the natural frequency determined according the moments of inertia of the shaft member coupled with the driven member l5Z and the like, while enabling two antiresonance points to be set.

The damper device 10Z may also be combined with a transmission TM for front wheel drive. The combination of the damper device 10Z with the transmission TM for front wheel drive also extremely effectively reduces the effect of the moment of inertia of the entire rotary inertia mass damper 20Z on the natural frequency determined according the moments of inertia of the shaft member coupled with the driven member 15Z and the like and achieves a further decrease in the stiffness to improve the vibration damping performance of the damper device 10Z. The damper device 10Z may include another intermediate member and other springs (elastic body) between the first intermediate member 13Z and the second intermediate member 14Z. Furthermore, in the damper device 10Z, the sun gear of the planetary gear 21 may be coupled with (integrated with) the drive member 11Z, and the driven member 15Z may be configured as the carrier of the planetary gear 21.

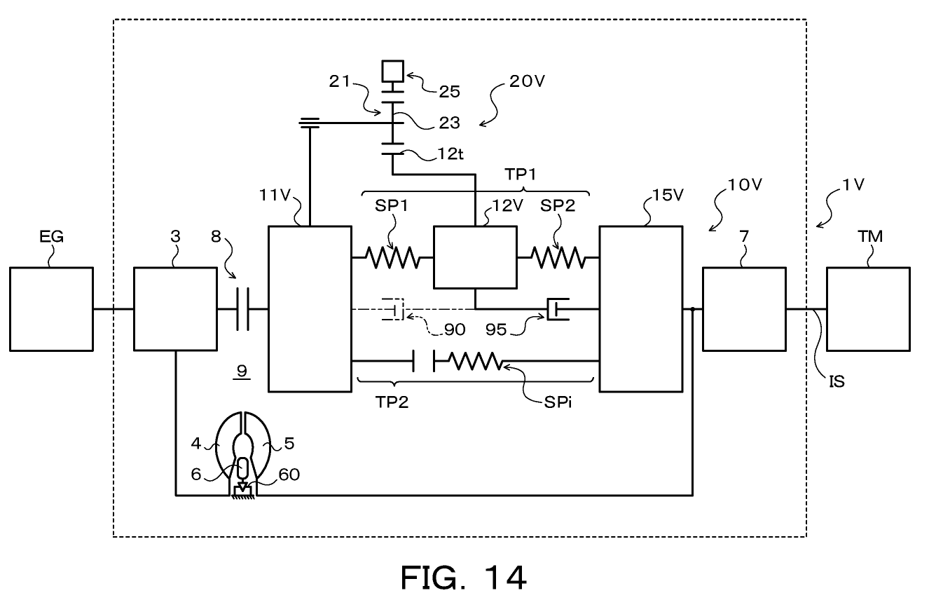

FIG. 14 is a schematic configuration diagram illustrating a starting device 1V including another damper device 10V of the present disclosure. Like components to those of the starting device 1 and the damper device 10 or the like described above among components of the starting device 1V and the damper device 10V are expressed by like reference signs, and the duplicated description is omitted.

The damper device 10V shown in FIG. 14 corresponds to a configuration that the rotary inertia mass damper 20 including the ring gear 25 as the mass body rotating with relative rotation between the drive member 11 and the driven member 15 is replaced by a rotary inertia mass damper 20V including a ring gear 25 as the mass body rotating with relative rotation between a drive member 11V and an intermediate member 12V in the damper device 10 shown in FIG. 1 and the other drawings. More specifically, in the damper device 10V, the rotary inertia mass damper 20V is provided in parallel with first springs SP1 between the drive member 11V and the intermediate member 12V. In the rotary inertia mass damper 20V, the drive member 11V supports a plurality of pinion gears 23 in a rotatable manner and serves as the carrier of the planetary gear 21, and the intermediate member 12V has external teeth 12t and serves as the sun gear of the planetary gear 21.

This damper device 10V is capable of setting one antiresonance point where the vibration transmitted from the drive member 11V to the intermediate member 12V via the first springs SP1 and the vibration transmitted from the drive member 11V to the intermediate member 12V via the rotary inertia mass damper 20V are theoretically cancelled out each other. In the damper device 10V, the first and the second springs SP1 and SP2 work in series between the drive member 11V and a driven member 15V. This configuration further reduces the combined spring constant of the first and the second springs SP1 and SP2.

Furthermore, the damper device 10V is provided with an attenuation mechanism 95 configured to generate a frictional force, for example, between the intermediate member 12V and the driven member 15V and attenuate the resonance of the intermediate member 12V as shown in FIG. 14. Even when coupling of the rotary inertia mass damper 20V with the intermediate member 12V substantially increases the moment of inertia of the intermediate member 12V and decreases the damping ratio ζ, the attenuation mechanism 95 serves to attenuate the resonance of the intermediate member 12V and suppresses an increase in the amplitude of the resonance. As a result, the damper device 10V effectively lowers the vibration level in the vicinity of a resonance point of the intermediate member 12V by the inertia torque transmitted from the rotary inertia mass damper 20V to the intermediate member 12V (driven member 15V). The configuration of generating the frictional force between the intermediate member 12V and the driven member 15V and attenuating the resonance of the intermediate member 12V reduces the effect of the frictional force on the operation of the rotary inertia mass damper 20V between the drive member 11V and the intermediate member 12V.

The damper device 10V may be provided with an attenuation mechanism 90 configured to generate a frictional force between the drive member 11V and the intermediate member 12V and attenuate the resonance of the intermediate member 12V as shown by a two-dot chain line in the drawing. The damper device 10V may be provided with both the attenuation mechanisms 90 and 95. The damper device 10V may also be provided with at least one of an attenuation mechanism configured to attenuate the resonance of the intermediate member 12V with varying the frictional force between the drive member 11V and the intermediate member 12V and an attenuation mechanism configured to attenuate the resonance of the intermediate member 12V with varying the frictional force between the intermediate member 12V and the driven member 15V. Furthermore, in the damper device 10V, the sun gear of the planetary gear 21 maybe coupled with (integrated with) the drive member 11V, and the intermediate member 12V may be configured as the carrier of the planetary gear 21.

As described above, a damper device (10, 10B, 10C, 10D, 10X, 10Y) according to the present disclosure is configured to include an input element (11, 11B, 11C, 11D, 11X, 11Y) to which a torque from an engine (EG) is transmitted; an intermediate element (12, 12B, 12C, 12D, 12X, 13, 14); an output element (15, 15B, 15C, 15D, 15X, 15Y); a first elastic body (SP1, SP1′) arranged to transmit a torque between the input element and the intermediate element; and a second elastic body (SP2, SP2′) arranged to transmit a torque between the intermediate element and the output element. The damper device (10, 10B, 10C, 10D, 10X, 10Y) further includes a rotary inertia mass damper (20, 20X, 20Y) that includes a mass body (25) rotating in accordance with relative rotation between the input element and the output element and that is arranged between the input element and the output element to be parallel to a torque transmission path (TP1, TP) including the first elastic body, the intermediate element and the second elastic body; and an attenuation mechanism (90, 95, 95D) configured to attenuate resonance of the intermediate element.

The damper device of the present disclosure enables a plurality of natural frequencies (resonance frequencies) to be set with regard to the torque transmission path including the intermediate element in the state that deflections of the first elastic body and the second elastic body are allowed and enables resonance of the intermediate element to occur when the rotation speed of the input element reaches a rotation speed corresponding to one of the plurality of natural frequencies. The damper device of the present disclosure is thus capable of setting two antiresonance points where the vibration transmitted from the input element to the output element via the torque transmission path and the vibration transmitted from the input element to the output element via the rotary inertia mass damper are theoretically cancelled each other. Making the frequencies of the two antiresonance points closer to the frequency of the vibration (resonance) that is to be attenuated by the damper device accordingly improves the vibration damping performance of the damper device. Furthermore, the damper device of the present disclosure includes the attenuation mechanism configured to attenuate the resonance of the intermediate element. This suppresses an increase in amplitude of the resonance of the intermediate element and effectively lowers the vibration level in the vicinity of a resonance point of the intermediate element (and a corresponding antiresonance point) by an inertia torque transmitted from the rotary inertia mass damper to the output element. As a result, this configuration further improves the vibration damping performance of the damper device.

The attenuation mechanism (90, 95, 95D) may be configured to generate a frictional force between the intermediate element (12, 12B, 12C, 12D, 12X, 13) and at least one of the input element (11, 11B, 11C, 11D, 11X, 11Y) and the output element (15, 15B, 15C, 15D, 15X, 15Y). This configuration further appropriately attenuates the resonance of the intermediate element.

The attenuation mechanism (90, 95D) may also be configured to generate a frictional force between the input element (11, 11B, 11C, 11D, 11X, 11Y) and the intermediate element (12, 12B, 12C, 12D, 12X, 13). This configuration effectively attenuates the resonance of the intermediate element, while suppressing a shift in the phase of the vibration transmitted from the input element to the output element via the torque transmission path by generation of the frictional force between the input element and the intermediate element.

The attenuation mechanism (90, 95D) may include a friction member (91, 96D) configured to rotate integrally with one of the input element (11, 11B, 11C, 11D, 11X, 11Y) and the intermediate element (12, 12B, 12C, 12D, 12X, 13); and an urging member (92, 97D) configured to urge the friction member from the one of the input element and the intermediate element toward the other.

The attenuation mechanism (95, 95D) may include a friction member (96, 96D) configured to rotate integrally with one of the intermediate element (12, 12B, 12C, 12D, 12X, 13) and the output element (15, 15B, 15C, 15D, 15X, 15Y); and an urging member (97, 97D) configured to urge the friction member from the one of the intermediate element and the output element toward the other.

The attenuation mechanism may include a first friction member (91, 96D) configured to rotate integrally with one of the input element and the intermediate element; a first urging member (92, 97D) configured to urge the first friction member from the one of the input element and the intermediate element toward the other; a second friction member (96, 96D) configured to rotate integrally with one of the intermediate element and the output element; and a second urging member (97, 97D) configured to urge the second friction member from the one of the intermediate element and the output element toward the other.

The attenuation mechanism (95D) maybe configured to vary the frictional force in accordance with a rotation speed of the input element (11, 11B, 11C, 11D, 11X, 11Y) or may be configured to increase the frictional force with an increase in rotation speed of the input element (11, 11B, 11C, 11D, 11X, 11Y). This decreases the frictional force generated at a low rotation speed of input element. This configuration thus extremely effectively attenuates the resonance of the intermediate element, while effectively suppressing a shift in the phase of the vibration transmitted from the input element to the output element via the torque transmission path accompanied with the generation of the frictional force.

A damping ratio (ζ) of the intermediate element that is determined based on a moment of inertia (J₂) of the intermediate element and stiffnesses (k₁, k₂) of the first and the second elastic bodies may be smaller than a value 1, and a rotation speed corresponding to a natural frequency (f₁₂) of the intermediate element maybe higher than a minimum rotation speed (Nlup) in a rotation speed range where a torque is transmitted from the input element to the output element via the torque transmission path. In the damper device of this aspect, resonance of the intermediate element occurs when the rotation speed of the input element becomes higher than the rotation speed corresponding to the frequency of a low rotation-side (low frequency-side) antiresonance point. The damper device provided with the attenuation mechanism to attenuate the resonance of the intermediate element more effectively lowers the vibration level in the vicinity of a high rotation-side (high frequency-side) antiresonance point.

The output element (15, 15B, 15C, 15D, 15X, 15Y) may be operatively coupled with an input shaft (IS) of a transmission (TM).

Another damper device (10Z) according to the present disclosure is configured to include an input element (11Z) to which a torque from an engine (EG) is transmitted; a first intermediate element (13Z); a second intermediate element (14Z); an output element (15Z); a first elastic body (SP1′) arranged to transmit a torque between the input element (11Z) and the first intermediate element (13Z); a second elastic body (SP2′) arranged to transmit a torque between the first intermediate element (13Z) and the second intermediate element (14Z); and a third elastic body (SP3) arranged to transmit a torque between the second intermediate element (14Z) and the output element (15Z). The damper device (10Z) further includes a rotary inertia mass damper (20Z) that includes a mass body (25) rotating in accordance with relative rotation between the input element (11Z) and the second intermediate element (14Z) and that is arranged to be parallel to the first elastic body (SP1′), the first intermediate element (13Z) and the second elastic body (SP2′); and an attenuation mechanism (90, 95) configured to attenuate resonance of the first intermediate element (13Z).

In the damper device of this aspect, the configuration that the rotary inertia mass damper is coupled with the input element and the second intermediate element of the damper device causes the third elastic body to be placed between the rotary inertia mass damper and a member coupled with the output element and thereby substantially separates the rotary inertia mass damper from the member coupled with the output element. This configuration extremely effectively reduces the effect of the moment of inertia of the entire rotary inertia mass damper on the natural frequency determined according the moments of inertia of the member coupled with the output element, while enabling two antiresonance points to be set. As a result, even when the member coupled with the output element of the damper device has low stiffness and the natural frequency (resonance frequency) determined according to the moment of inertia of the member is lowered by the effect of the moment of inertia of the entire rotary inertia mass damper, this configuration effectively suppresses resonance that is expected to occur at a high rotation speed of the input element from occurring apparently in a low rotation range. Furthermore, the damper device coupled with the attenuation mechanism to attenuate the resonance of the first intermediate element suppresses an increase in the amplitude of the resonance of the first intermediate element and effectively lowers the vibration level in the vicinity of a resonance point of the first intermediate element (and a corresponding antiresonance point) by the inertia torque transmitted from the rotary inertia mass damper to the output element. As a result, this configuration further improves the vibration damping performance of the damper device.

Another damper device (10V) according to the present disclosure is configured to include an input element (11V) to which a torque from an engine (EG) is transmitted; an intermediate element (12V); an output element (15V); a first elastic body (SP1) arranged to transmit a torque between the input element (11V) and the intermediate element (12V); and a second elastic body (SP2) arranged to transmit a torque between the intermediate element (12V) and the output element (15V). The damper device (10V) further includes a rotary inertia mass damper (20V) that includes a mass body (25) rotating in accordance with relative rotation between the input element (11V) and the intermediate element (12V) and that is arranged between the input element (11V) and the intermediate element (12V) to be parallel to the first elastic body (SP1); and an attenuation mechanism (90) configured to attenuate resonance of the intermediate element (12V).

In the damper device of this aspect, even when coupling of the rotary inertia mass damper with the intermediate element substantially increases the moment of inertia of the intermediate element and decreases the damping ratio ζ, the attenuation mechanism serves to attenuate the resonance of the intermediate element and suppresses an increase in the amplitude of the resonance. As a result, the damper device of this aspect effectively lowers the vibration level in the vicinity of a resonance point of the intermediate element by the inertia torque transmitted from the rotary inertia mass damper to the intermediate element (driven member). As a result, this configuration further improves the vibration damping performance of the damper device.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The disclosure is applicable to, for example, the manufacturing industries of damper devices.

1. A damper device configured to include an input element to which a torque from an engine is transmitted; an intermediate element; an output element; a first elastic body arranged to transmit a torque between the input element and the intermediate element; and a second elastic body arranged to transmit a torque between the intermediate element and the output element, the damper device comprising:
a rotary inertia mass damper that includes a mass body rotating in accordance with relative rotation between the input element and the output element and that is arranged between the input element and the output element to be parallel to a torque transmission path including the first elastic body, the intermediate element and the second elastic body; and
an attenuation mechanism configured to attenuate resonance of the intermediate element.

2. The damper device according to claim 1,
wherein the attenuation mechanism is configured to generate a frictional force between the intermediate element and at least one of the input element and the output element.

3. The damper device according to claim 1,
wherein the attenuation mechanism is configured to generate a frictional force between the input element and the intermediate element.

4. The damper device according to claim 3,
wherein the attenuation mechanism includes a friction member configured to rotate integrally with one of the input element and the intermediate element; and an urging member configured to urge the friction member from the one of the input element and the intermediate element toward the other.

5. The damper device according to claim 2,
wherein the attenuation mechanism includes a friction member configured to rotate integrally with one of the intermediate element and the output element; and an urging member configured to urge the friction member from the one of the intermediate element and the output element toward the other.

6. The damper device according to claim 2,
wherein the attenuation mechanism includes a first friction member configured to rotate integrally with one of the input element and the intermediate element; a first urging member configured to urge the first friction member from the one of the input element and the intermediate element toward the other; a second friction member configured to rotate integrally with one of the intermediate element and the output element; and a second urging member configured to urge the second friction member from the one of the intermediate element and the output element toward the other.

7. The damper device according to claim 2,
wherein the attenuation mechanism is configured to vary the frictional force in accordance with a rotation speed of the input element.

8. The damper device according to claim 7,
wherein the attenuation mechanism is configured to increase the frictional force with an increase in rotation speed of the input element.

9. The damper device according to claim 1,
wherein a damping ratio of the intermediate element that is determined based on a moment of inertia of the intermediate element and stiffnesses of the first and the second elastic bodies is smaller than a value 1, and wherein a rotation speed corresponding to a natural frequency of the intermediate element is higher than a minimum rotation speed in a rotation speed range where a torque is transmitted from the input element to the output element via the torque transmission path.

10. The damper device according to claim 1,
wherein the output element is operatively coupled with an input shaft of a transmission.

11. A damper device configured to include an input element to which a torque from an engine is transmitted; a first intermediate element; a second intermediate element; an output element; a first elastic body arranged to transmit a torque between the input element and the first intermediate element; a second elastic body arranged to transmit a torque between the first intermediate element and the second intermediate element; and a third elastic body arranged to transmit a torque between the second intermediate element and the output element, the damper device comprising:
a rotary inertia mass damper that includes a mass body rotating in accordance with relative rotation between the input element and the second intermediate element and that is arranged to be parallel to the first elastic body, the first intermediate element and the second elastic body; and
an attenuation mechanism configured to attenuate resonance of the first intermediate element.

12. A damper device configured to include an input element to which a torque from an engine is transmitted; an intermediate element; an output element; a first elastic body arranged to transmit a torque between the input element and the intermediate element; and a second elastic body arranged to transmit a torque between the intermediate element and the output element, the damper device comprising:
a rotary inertia mass damper that includes a mass body rotating in accordance with relative rotation between the input element and the intermediate element and that is arranged between the input element and the intermediate element to be parallel to the first elastic body; and
an attenuation mechanism configured to attenuate resonance of the intermediate element.
